(19) United States
(12) Patent Application Publication
(10) Pub. No.: US 2012/0120845 A1
(43) Pub. Date: May 17, 2012

(54) PEER DISCOVERY, TARGET SELECTION, AND FLOW REPLICATION FOR INTER USER EQUIPMENT TRANSFERS

(75) Inventors: Michelle Perras, Montreal (CA); Xavier De Foy, Kirkland (CA); Kamel M. Shaheen, King of Prussia, PA (US); Milan Patel, Harrow (GB)

(73) Assignee: InterDigital Patent Holdings, Inc., Wilmington, DE (US)

(21) Appl. No.: 13/106,614

(22) Filed: May 12, 2011

Related U.S. Application Data
(60) Provisional application No. 61/333,791, filed on May 12, 2010.
(60) Provisional application No. 61/357,465, filed on Jun. 22, 2010.

(51) Int. Cl. H04W 4/08; H04W 4/06

(52) U.S. Cl. 370/254; 370/312

(57) ABSTRACT

Systems, methods, and apparatus are described herein for enabling the transfer of media flow to user equipment (UE) in a network using a mobile IP (MIP) protocol. The media flow may be transferred among UEs that are members of the same group of UEs. UEs, Home Agents (HAs), and/or Session Controllers (SCs) may be implemented in the network to maintain each group and/or transfer media flow between members of the group of UEs. The media flow may be replicated before being sent to the members of the group of UEs. UEs, HAs, SCs, REPLICATORs, and/or Authorization Entities (AEs) may be implemented in replicating media flows as described herein.

### CROSS REFERENCE TO RELATED APPLICATIONS

This application claims the benefit of U.S. Provisional Patent Application Ser. No. 61/333,791, filed May 12, 2010, and U.S. Provisional Patent Application Ser. No. 61/357,465, filed Jun. 22, 2010, the contents of which are hereby incorporated by reference herein.

### BACKGROUND

Multimedia application information, multimedia “flows” (which may be referred to as media flows, or simply, flows), may be communicated to mobile nodes or user equipment (UE) across one or more wireless communication networks. A UE may include any device that may communicate with communications networks, including, but not limited to, mobile devices (e.g., mobile phones, mobile media devices, mobile computers, etc.), computing devices, media devices (e.g., video devices, audio devices, data devices, etc.), telephone devices (including landline devices), etc. A media flow may be transferred from one mobile node or UE to another mobile node or UE.

Such media flow transfers may be referred as Inter UE transfers (IUTs). IUTs may support transfers among IP Multimedia Subsystem (IMS) devices using session initiation protocol (SIP). However, there is no media flow transfer between different non-IMS devices in non-IMS based services. Currently, there is no known solution for peer UEs to dynamically and efficiently discover each other or to select a peer target, nor is there a solution to associate UEs together in a group, and/or to facilitate information exchange among UEs within a group.

Traffic replication and transfer are useful in a network to enable data to be transferred among multiple destinations, while maintaining a single session. Currently, however, there is also no support for traffic replication using Mobile IP.

### SUMMARY

This Summary is provided to introduce various concepts in a simplified form that are further described below the Detailed Description.

Systems, methods, and apparatus embodiments are described for configuring a group of user equipment that may be used to transfer media flow between members of the group of user equipment. As described herein, a group request message may be received that is associated with a first user equipment and a group of user equipment. The group of user equipment may then be configured based on the group request message. For example, the group request message may include a join group request message, a leave group request message, an update group request message, a query group request message, and/or a data group request message.

Systems, methods, and apparatus embodiments are described for enabling the transfer of a data flow between members of a group of user equipment. For example, an indication may be received to join the first user equipment to the group of user equipment. A mobile IP group request message may be sent that is configured to join a first user equipment to the group of user equipment. Data may be received that is associated with a second user equipment that is a member of the group of user equipment. A data flow may then be transferred to the second user equipment based on the receive data.

Systems, methods, and apparatus embodiments are described for replicating media flow in a network for transmission to a user device. As described herein, a request may be received to replicate a media flow towards a plurality of user equipment. A replication request message may be sent to the plurality of user equipment. The media flow may be replicated and the replicated media flow may be sent to the plurality of user equipment.

### BRIEF DESCRIPTION OF THE DRAWINGS

FIG. 1 illustrates an example embodiment of a system for transferring media session control between terminals;

FIG. 2 illustrates an example IP Multimedia Subsystem (IMS) based Inter-UE transfer (IUT) procedure;

FIG. 3 illustrates of an example architecture of IUT peer discovery and target selection;

FIG. 4A is a flow diagram illustrating an exemplary process for joining a user equipment (UE) to a group;

FIG. 4B is a flow diagram illustrating an another exemplary process for joining a UE to a mobile IP (MIP) group;

FIG. 5A is a flow diagram illustrating an exemplary process for removing a UE from an MIP group;

FIG. 5B is a flow diagram illustrating another exemplary process for removing a UE from an MIP group;

FIG. 6 is a flow diagram illustrating an exemplary process for updating an MIP group;

FIG. 7 is a flow diagram illustrating an exemplary process for determining information regarding an MIP group;

FIG. 8 is a flow diagram illustrating an exemplary process for sending a data group request message between UEs belonging to an MIP group;

FIG. 9 is a flow diagram that illustrates an example IUT peer discovery process using MIP group functionality;

FIG. 10 is a flow diagram that illustrates an example IUT target peer selection process using MIP group functionality;

FIG. 11 illustrates an example message data field having MIP Group Extensions;

FIG. 12 illustrates an example message data field having MIP Group Extensions;

FIG. 13 illustrates an example architecture for group functionality support with proxy MIP implemented in the network;

FIG. 14 is a flow diagram of a pull mode network wherein information from a remote party is being replicated and transmitted to a user equipment (UE);

FIG. 15 is a flow diagram of a push mode network wherein information associated with a controller UE is being replicated and transmitted to a controllee UE;

FIG. 16 is a flow diagram of a pull mode network wherein information associated with a controller UE is being replicated and transmitted to a controllee UE;

FIG. 17 is a block diagram showing a UE making a request to replicate a flow towards other UEs where a Home Agent (HA) handles authorization, session control and data replication, in accordance with one embodiment;

FIG. 18 is a block diagram showing a UE making a request to replicate a flow towards other UEs where an HA interacts with a REPLICATOR for data replication;

FIG. 19 is a block diagram showing a UE making a request to replicate a flow towards other UEs where an HA interacts with a Session Controller (SC) for session control of control information, in accordance with one embodiment;

FIG. 20 is a block diagram showing a UE making a request to replicate a flow towards other UEs where an HA interacts with an Authorization Entity (AE) for authorization and an SC for session control of control information, in accordance with one embodiment;

FIG. 21 is a block diagram showing a UE making a request to replicate a flow towards other UEs where an HA interacts with a REPLICATOR for session control of control information, in accordance with one embodiment;

FIG. 22 illustrates the registration of HAs with a SC on behalf of associated UEs when the SC is handling session control of control information, in accordance with one embodiment;

FIG. 23 is a block diagram showing the sharing of registration among multiple HAs when the HAs are handling session control of control information, in accordance with one embodiment;

FIG. 24 is a block diagram showing the registration of HAs with a REPLICATOR on behalf of associated UEs when the REPLICATOR is handling session control of control information, in accordance with one embodiment;

FIG. 25 is a block diagram showing data being received from a CN and replicated at a HA to share the data among UEs, in accordance with one embodiment;

FIG. 26 is a block diagram showing data being received from a CN and replicated at a REPLICATOR or SC to share the data among UEs, in accordance with one embodiment;

FIG. 27 is a block diagram showing data that is generated at a UE being shared with other UEs while a HA handles the data replication, in accordance with one embodiment;

FIG. 28 is a block diagram showing data that is generated at a UE being shared with other UEs while a REPLICATOR or SC handles the data replication, in accordance with one embodiment;

FIG. 29 shows a sequence flow diagram where a HA may be handling data replication and/or session control, in accordance with one embodiment;

FIG. 30 shows a sequence flow diagram where a REPLICATOR and a SC may be used in handling data replication and/or session control, in accordance with one embodiment;

FIG. 31 shows a sequence flow diagram where a replication request originates from a target UE and a REPLICATOR and a SC may be used in handling data replication and/or session control, in accordance with one embodiment;

FIG. 32 illustrates a replication mobility option that may be implemented in an MIP protocol, in accordance with one embodiment;

FIG. 33 illustrates the use of a reference bit used in a binding update message, in accordance with one embodiment;

FIG. 34A is a system diagram of an example communications system in which one or more disclosed embodiments may be implemented;

FIG. 34B is a system diagram of an example wireless transmit/receive unit (WTRU) that may be used within the communications system illustrated in FIG. 34A;

FIG. 34C is a system diagram of an example radio access network and an example core network that may be used within the communications system illustrated in FIG. 34A;

FIG. 34D is a system diagram of an another example radio access network and an another example core network that may be used within the communications system illustrated in FIG. 34A; and

FIG. 34E is a system diagram of an another example radio access network and an another example core network that may be used within the communications system illustrated in FIG. 34A.

### DETAILED DESCRIPTION

A detailed description of illustrative embodiments is described with reference to the FIGs. Although this description may provide detailed descriptions of possible embodiments, it should be noted that the details are intended to be exemplary and in no way limit the scope of the disclosed embodiments.

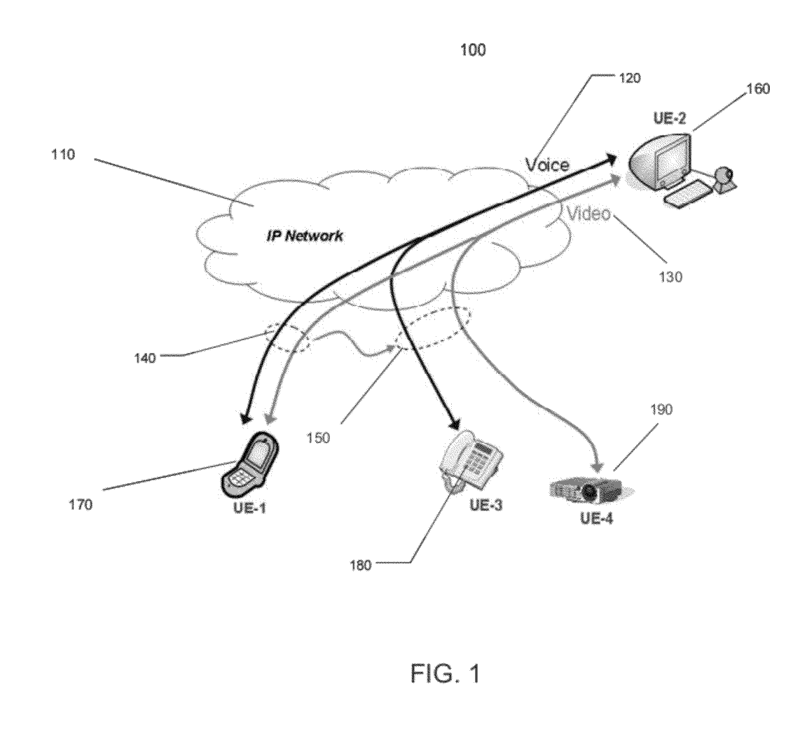

FIG. 1 illustrates an example embodiment of a system 100 for transferring a media session control between terminals. This may be done to enable the transfer of media flows from one terminal, such as the mobile device 170, to a second terminal, such as the computer 160. The terminals may include any device which may receive, transmit, use, store, and/or display media, such as, but not limited to, a user equipment (UE), a computer, a fixed phone, and/or a projector, as illustrated in FIG. 1 for example. For example, a mobile device user may decided to transfer a voice component, such as voice component 120, of a media session to a fixed phone, such as the fixed phone 180, and/or a video component, such as the video component 130, of the same media session to a video projection, such as the projector 190. According to an example embodiment, the system 100 may include the IP network 110. The IP network 110 may be a network such as a Public Land Mobile Network (PLMN), an IP Multimedia Subsystem (IMS) network, corporate intranet, a Fixed-End System (FES), the public Internet, or the like. Network elements such as routers, gateways switches, and/or the like, may be included within the IP network 110.

As illustrated in FIG. 1, the IP network 110 may be in operative communication with one or more mobile nodes, wireless transmit/receive units (WTRU), or UEs, such as the mobile device 170 for example. The network 110 may be in operative communication with the fixed phone 180, the projector 190, the computer 160, or the like. The configurations and the communications between the IP network 110 and the mobile devices and/or UEs is provided for illustrative purposes only, and as such, the communications between the specified UEs may be between different elements and/or through additional elements and/or different signaling/commands may be used.

In an example embodiment, a user associated with the mobile device 170 may establish a multimedia flow with a remote party associated with the computer 160. The multimedia flow may include one or more media components, such as a voice component 120 and/or a video component 130. The fixed line 180 and/or the projector 190 may be in operative connection with the IP network 110, the mobile device 170, and/or the computer 160. The fixed line 180 and/or the projector 190 may belong to one or more IMS subscriptions. These IMS subscriptions may differ from the IMS subscription of the mobile device 170. Additionally, the fixed line 180 and/or the projector 190 may belong to one or more network operators. These network operators may differ from the network operator of the mobile device 170.

A multimedia flow between the fixed line 180 and/or the projector 190 may be established with the remote party, such as the computer 160. The media flow may be received at the fixed line 180 and/or the projector 190. In another embodiment, the media flow may be broken into components and each component may be received by the fixed line 180 and/or the projector 190. For example, the voice component 120 of the media flow may be transferred to the fixed line 180 and the video component of the media flow may be transferred to the projector 190. When the media flow is received at the fixed line 180 and/or the projector 190, a collaborative session 150 may be established. Collaborative session control may be transferred from mobile device 170 to the fixed line 180 and/or the projector 190. For example, the collaborative session 150 may permit the fixed line 180 and/or the projector 190 to maintain control over the voice component 120 and/or the video component 130. In one embodiment, the collaborative session 140 may be terminated after collaborative session control and/or control over the media flow may be transferred to the collaborative session 150.

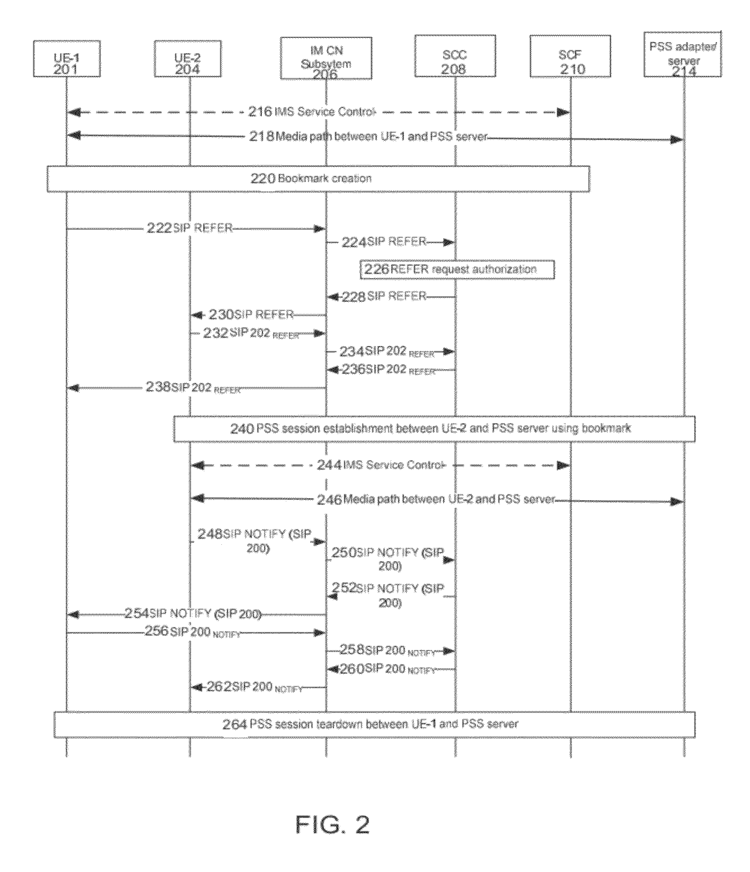

FIG. 2 illustrates an example IMS-based IUT procedure. According to one exemplary embodiment, as illustrated in FIG. 2, UE-1 201 and service control function (SCF) 210 may communicate IMS Service Control information 216 between each other. The UE-1 201 and the PSS adapter/server 214 may communicate using media path 218. A bookmark may be created at 220. UE-1 201 may send a session initiation protocol (SIP) reference message 222 to the IP Multimedia Core Network (IM CN) Subsystem 206. The IM CN Subsystem 206 may forward SIP reference message 224 to the Session Continuity Controller (SCC) 208. SCC 208 may perform a reference request authorization 226 and send SIP reference message 228 to IM CN Subsystem 206. IM CN Subsystem 206 may send SIP reference message 230 to UE-2 204. UE-2 204 may then send SIP message 232, which may include SIP 202 reference information. IM CN Subsystem 206 may send SIP 202 reference message 234 to SCC 208. SCC 208 may send SIP 202 reference message 236 to IM CN Subsystem 206. IM CN Subsystem 206 may send SIP 202 reference message 238 to UE-1 201. At 240, a PSS session may be established between UE-2 204 and PSS adapter/server 214. The PSS session may be established using a bookmark for example.

SCF 210 and UE-2 204 may communicate IMS Service Control information 244 between each other. The UE-2 204 and the PSS adapter/server 214 may communicate using media path 246. UE-2 204 may send an SIP notification message 248 to IM CN Subsystem 206. The IM CN Subsystem 206 may send SIP notification message 250 to SCC 208. SCC 208 may send SIP notification message 252 to IM CN Subsystem 206 and IM CN Subsystem 206 may send SIP notification message 254 to UE-1 201. SIP 200 notification message 256 may be sent from UE-1 201 to IM CN Subsystem 206 and IM CN Subsystem 206 may send SIP 200 notification message 258 to SCC 208. SCC 208 may send SIP 200 notification message 260 to IM CN Subsystem 206 and IM CN Subsystem 206 may forward SIP 200 notification message 262 to UE-2 204. At 264, the PSS session between UE-1 201 and PSS adapter/server 214 may be torn down. At 264 the IUT may be completed and media traffic may flow to UE-2 204.

In an embodiment, MIP protocol may be enhanced to support group functionalities. For example, IUT procedures using MIP protocol may use the MIP group functionalities to narrow potential targets for IUT. For example, UEs that are a member of a group may be considered for IUT. This may be more efficient than querying or discovering UEs that support IUT functionalities but may be unavailable for media flow transfers. In addition, information exchange between members of a group may be performed in an efficient manner, minimizing the number of messages sent over-the-air.

In an embodiment, the MIP protocol may support group functionality. For example, the MIP protocol may include a group request message to handle functions such as join a group, leave a group, renew the group membership (e.g., update), send data to members of a group (e.g., on application level), obtain the list of members of a group (e.g., indication/query), or the like.

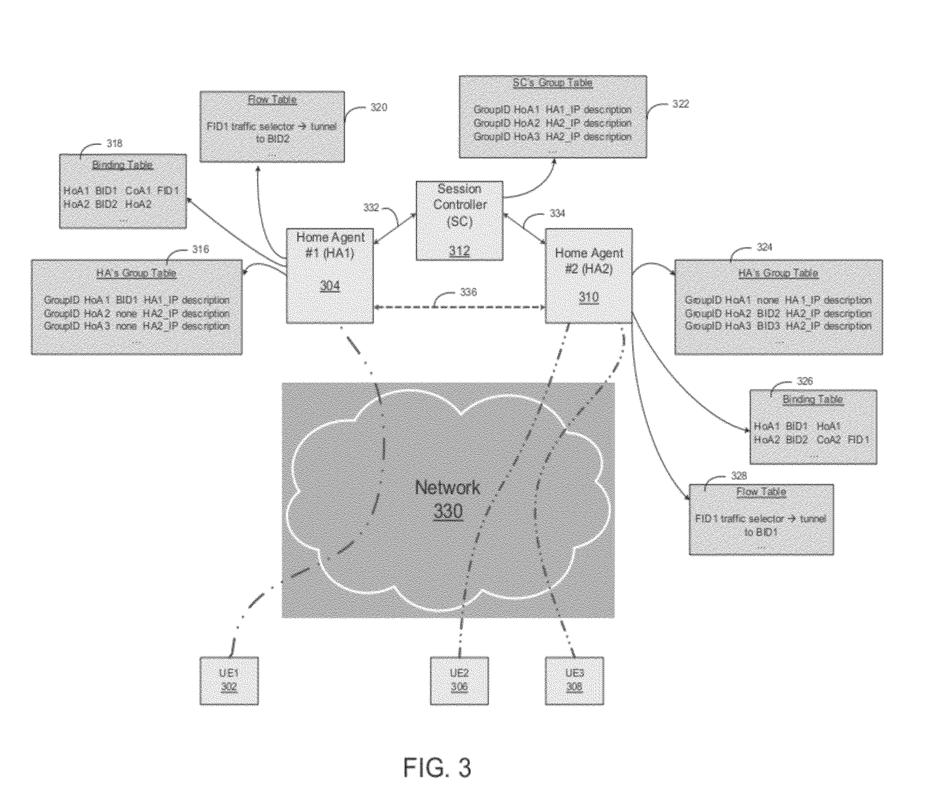

FIG. 3 depicts an example architecture of IUT peer discovery and target selection. In an embodiment, multiple UEs may belong to the same group of UEs served by a home agent (HA). As shown in FIG. 3, UE1 302 may be served by a home agent, such as HA1 304, while the UE2 306 and UE 308 may be served by another home agent, such as HA2 310. UE1 302, UE2 306, and UE3 308 may communicate with each other via Network 330. The communications between each UE and its serving HA may be performed using MIP protocol messages and/or other protocol messages for example.

Each HA may locally maintain a group table, a binding table, and/or a flow table. For example, HA1 304 may locally maintain group table 316, binding table 318, and/or flow table 320, while HA2 310 may maintain group table 324, binding table 326, and/or flow table 328. Group table 316 and group table 324 may include an entry for each member of a group. For example, group table 316 and group table 324 may include one or more entries for a UE in the group or may be empty. Each entry in the table may have a corresponding home address (HoA), a binding identifier (BID) corresponding to the UE served by the HA in which the group table is stored (e.g., BID1 or BID2), an HA IP address corresponding to the HA serving the UE (e.g., HA1 IP or HA2 IP), and/or a description of the UE. Binding tables 318 and 326 may include HoA information, binding identification information, Care-of-Address (CoA) information, and/or FID information for one or more HAs. Flow table 320 and flow table 328 may include an FID traffic selector and/or tunnel to a binding identification location.

The Session Controller (SC) 312 may forward MIP group messages from an HA to other HAs. For example, the group table 316 maintained by HA1 304 may be received by SC 312 at 332 and forwarded by SC 312 to HA2 310 at 334. Communications between each HA and the SC 312 may be performed using MIP protocol messages and/or other protocol messages for example. In one example embodiment, the SC 312 may maintain a group table, such as group table 322. Group table 322 may be received from HA1 304 and/or HA2 310 for example. Group table 322 may include one or more entries for a UE in each of one or more groups or the group table 322 may be empty. Each entry in group table 322 may have a corresponding home address (HoA), an HA IP address corresponding to the HA serving the UE (e.g., HA1 IP or HA2 IP), and/or a description of the UE.

In an alternative embodiment, the network may not include an SC, and the HA1 304 may directly communicate to HA2 310 at 336. Communications between the HA1 304 and HA2 310 may be performed using MIP protocol messages and/or other protocol messages for example.

In an embodiment, a group may be identified via a unique identifier. Groups may be pre-configured by the operator, one or more UE users, and/or another entity interested in configuring groups within a network. For example, groups such as Roger's group, phone group, or the like may be configured by a network operator. Groups may be configured dynamically by the operator, one or more UE users, and/or another entity interested in configuring groups within a network. For example, groups such as MyGroup, OfficeGroup, FriendsGroup, FamilyGroup, or the like may be configured by a particular UE user. Each group may be used to send data and/or media flow between members of the group.

Group messages may be propagated to members by HAs and/or the SC. For example, group messages (e.g., join messages and/or leave messages) may be duplicated and/or sent to HAs (e.g., via the SC) that may be serving members in the group. The HAs may maintain an accurate list of groups and the associated members. For example, original DATA group messages may be duplicated and directly sent to members of the group. Applications may use the DATA group mechanism to exchange information at application level with potential target UEs. For example, an application may want to know whether a potential target UE may support the application or the application may check the current load on a potential target UE.

In an embodiment, a UE may obtain the list of members of a specific group from its serving HA. For example, before a UE initiates an IUT, the UE may send a query, such as a QUERY group message, to its serving HA. The UE may request to be informed of changes related to the group membership. A UE may query a group of which the UE may be a member. Depending on the authorization information, the UE may query a group of which the UE may not be a member. Authorization may be configured and/or handled by the HA and/or the SC for example. In an embodiment, a query request may be rejected if the UE is not authorized to query groups of which the UE is not a member.

A UE may obtain application level information from discovered peers by exchanging messages with the peers. For example, before a UE initiates an IUT, the UE may send a message to a peer group member, or a potential target UE, to find out whether the UE supports a particular application. This mechanism may enable the exchange of other information among group members.

As described herein, a network may include a session control node such as a Session Controller (SC). The SC may be used to handle forwarding of MIP Group messages to HAs that have at least one UE registered in a current group. The SC may maintain a table of groups, associated HA's, and/or registered members. Each HA may not know the other HAs involved in a group.

Alternatively, the SC functionality may be added to the HAs if the SC is not present in the network. If the SC is not implemented in the network, each HA may interact directly with other HAs. In this case, each HA may know and use the IP address of the other HAs in performing communications with the other HAs.

In an embodiment, IUT procedures using MIP protocol may use the MIP group functionalities in IUT peer discovery and/or IUT target peer selection procedures. In an embodiment, the MIP group functionality may define peer discovery methods and may facilitate the target peer selection.

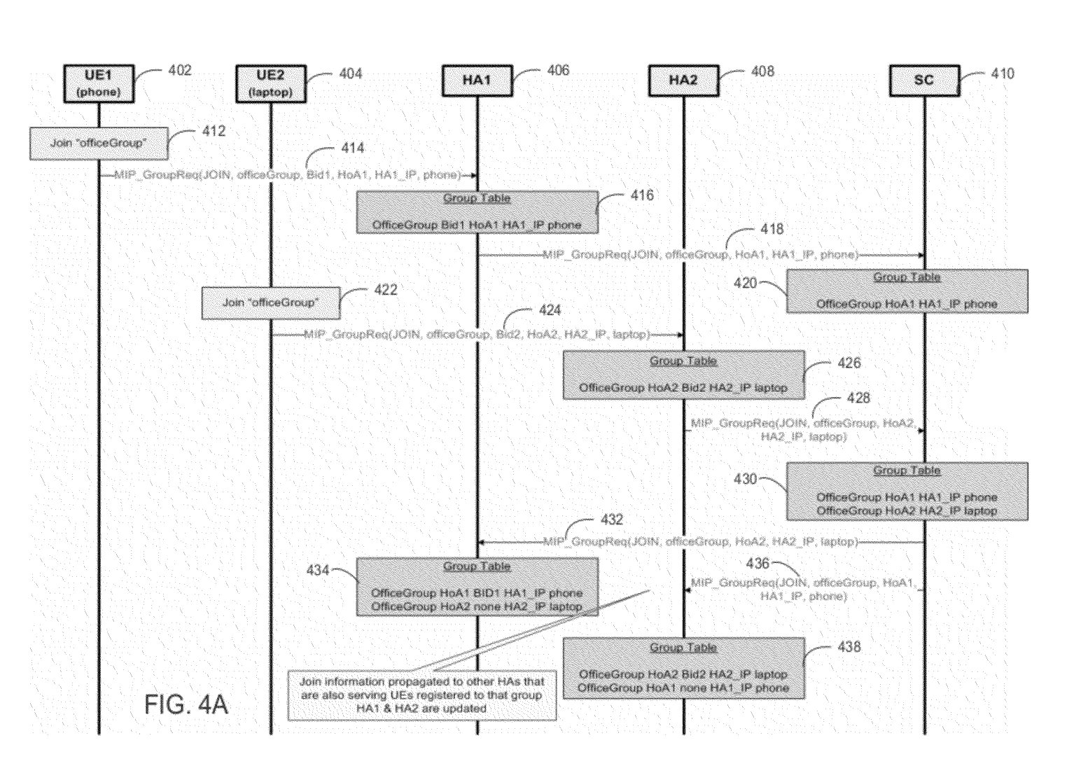

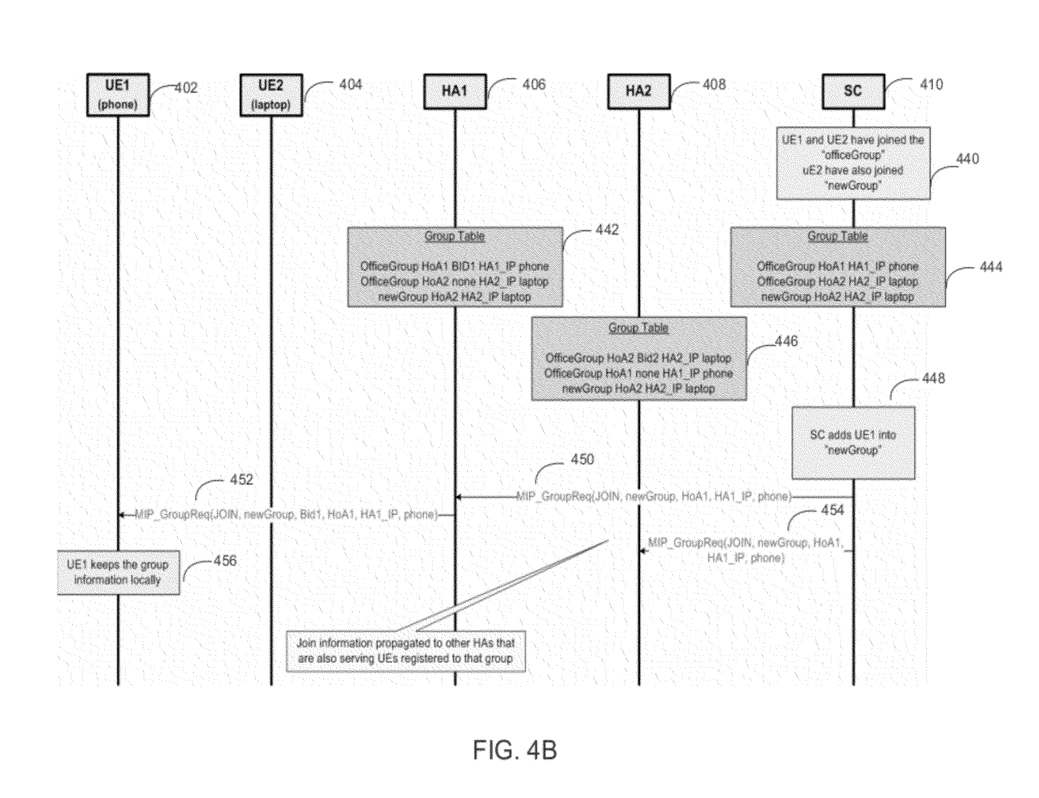

FIGS. 4A, 4B, 5A, 5B, and 6-8 illustrate example functionalities for the MIP group. According to one implementation, the functionalities illustrated in FIGS. 4A, 4B, 5A, 5B, and 6-8 may be used for sharing media flow between members of a group. In an embodiment, a JOIN group request may be used to join a UE to a group for sharing media flow. For example, a UE may send a request such as a JOIN group request to join a group. In an example, a user of the UE may dynamically create a new group or dynamically configure an existing group. The user may create a group and/or join a group using a JOIN group request message. Upon receiving an approval to join, or a confirmation that the UE has joined the group, or, after the UE learns that the SC and/or the HA has dynamically added the UE to a group, the UE may locally keep track of the membership to that group.

The disclosed systems, methods, and apparatus provide for performing an IUT among multiple devices within a network. An IUT may be performed from one interface or device to another. For example, as described herein, an IUT may be performed from a mobile phone to a local area network (LAN) line phone. Each device may discover select targets for IUT. To facilitate the IUT, data and/or media flow replication may be performed. For example, media flow replication may be performed prior to performing the IUT. Mobile IP (MIP) and/or IUT protocols may be implemented for performing the IUT and/or replication.

In an embodiment, the disclosed systems, methods, and apparatus provide for an inter-UE transfer (IUT) based peer discovery and target selection. Mobile IP (MIP) and/or IUT protocols may be used for IUT-based methods or processes as described herein. Although the disclosed embodiments may be generally illustrated herein by reference to MIP or IUT protocol, the embodiments are not limited to embodiments with Mobile IP or IUT protocol.

In an embodiment, MIP protocol may be used to support group functionalities. For example, IUT procedures using MIP protocol may use the MIP group functionalities to narrow potential targets for IUT. In an embodiment, the MIP group functionality may define a peer discovery method and/or may facilitate the target peer selection. For example, a UE may send a request for information related to a UE group. A home agent (HA) may receive the request and/or send information associated with one or more UEs of the UE group to the requesting UE. The requesting UE may then select a target UE for transferring a data flow based on the information received. In an embodiment, the network may include a session control node such as a Session Controller (SC) as described herein. The SC functionality may be added to the HAs if an SC is not present in the network.

An HA may maintain a group table that may store information related to duplicating and sending group messages to members of the group. The group table may be linked to, or be part of a binding table. For example, the group table may include information indicative of a group identifier, a UE's home IP address, a binding identifier, or “none” if the UE is not registered with the current HA, the IP address of the HA serving the specified UE, a description of the UE (e.g., laptop, TV, phone, etc), or other information related to members in the group.

The HA may receive a request such as a JOIN Group request to join a specific group. The HA may add the UE to the group table. If the UE is sending the JOIN request and is served by the HA, the JOIN request may be forwarded to the SC which may propagate it to the HAs that may have at least one UE registered to the group. If there is no SC used in the network, the JOIN request may be directly propagated to the other HAs (e.g., HAs may be configured with a list of other HAs). If the SC is sending the JOIN request and the UE is served by the HA, the JOIN request may be forwarded to the concerned UE.

The SC may maintain a group table that may include information related to duplicating and/or sending group messages to HAs serving members of the group. For example, the group table may include information indicative of group identifier, a UE's home IP address, the IP address of the HA serving the specified UE, a description of the UE (e.g. laptop, TV, phone, etc), and/or other information related to members in the group.

The SC may receive a request, such as a JOIN group request to join a specific group for example. The SC may add information related to the UE to the group table. The SC may forward the JOIN message to the HAs that have at least one UE registered to the group. The SC may also send a request such as a JOIN group request to request a UE to join a group. The SC may dynamically add a UE to a group. The message may be sent to the serving HA and to the HA's that may have at least one UE registered to the group.

FIGS. 4A and 4B are flow diagrams illustrating an example process for a UE to join a group. For example, FIG. 4A is a flow diagram illustrating a process that may be used by a UE to join itself to a group. As illustrated in FIG. 4A, at 412, UE1 402 may receive an indication to join a group entitled “officeGroup” and may send a JOIN group request 414 to HA1 406. The JOIN group request message 414 may include parameters indicating that the group request is a JOIN group request, the name of the group (e.g., officeGroup), a binding identifier, an HoA identifier, an HA IP address, and/or a UE type (e.g., phone). The HA1 406 may create a group table 416 corresponding to the officeGroup. The group table 416 may include the name of the group (e.g., officeGroup), the binding identifier associated with UE1, the HoA1 identifier, the HA1 IP address, and/or the UE type (e.g., phone).

The HA1 406 may send a JOIN group request message 418 to SC 410. The JOIN group request message 418 may include parameters indicating that the group request is a JOIN group request, the name of the group (e.g., officeGroup), an HoA identifier (e.g., HoA1), an HA IP address (e.g., HA1 IP), and/or a UE type (e.g., phone). The SC 410 may create a group table at 420 corresponding to the officeGroup. The group table at 420 may include the name of the group (e.g., officeGroup), the HoA identifier corresponding to the entry in the group (e.g., HoA1), the HA IP address corresponding to the entry in the group (e.g, HA1 IP), and/or the UE type (e.g., phone).

As illustrated in FIG. 4A, a user of UE2 404 may decide that they want to join the officeGroup at 422. A JOIN group request message 424 may be sent to HA2 408, which is the HA serving the UE2 404. The JOIN group request 424 may include parameters indicating that the group request is a JOIN group request, the name of the group (e.g., officeGroup), a binding identifier associated with UE2 404 (e.g., Bid2), an HoA associated with UE2 404 (e.g., HoA2), an HA IP address associated with HA2 408 (e.g., HA2 IP), and/or a UE type (e.g., laptop). The HA2 408 may create a group table at 426 for the officeGroup. The group table 426 may include the name of the group (e.g., officeGroup), the binding identifier associated with UE2, the HoA2, the HA2 IP address, and/or the UE type (e.g., laptop).

The HA2 408 may send a JOIN group request 428 to SC 410. The JOIN group request 428 may include parameters indicating that the group request is a JOIN group request, the name of the group (e.g., officeGroup), an HoA identifier (e.g., HoA2), an HA IP address (e.g., HA2 IP), and/or a UE type (e.g., laptop). The SC 410 may add an entry to the group table at 430 that indicates that UE2 404 is a member of the officeGroup. The group table at 430 may include an entry for each member that has joined the group. For example, the group table at 430 may include an entry corresponding to UE1 402 and an entry corresponding to UE2 404. Each entry may include the name of the group (e.g., officeGroup), the HoA corresponding to the entry (e.g., HoA1 or HoA2), the HA IP address corresponding to the entry (e.g., HA1 IP or HA2 IP), and/or the UE type corresponding to the entry (e.g., phone or laptop).

When a UE joins a group, the SC 410 may send join information to other HAs that are serving UEs registered to that group. For example, SC 410 may send a JOIN group request message 432 to HA1 406 that indicates that another member has joined the group to which UE1 402 is a member. The JOIN group request message 432 may include parameters indicating that another member joined the group, the name of the group (e.g., officeGroup), an HoA associated with the UE that joined the group (e.g., HoA2), an HA IP address associated with the UE that joined the group (e.g., HA2 IP), and/or a UE type associated with the UE that joined the group (e.g., laptop).

After HA1 406 receives the JOIN group request message 432, HA1 406 may update its group table at 434. For example, HA1 406 may add an entry for UE2 404 to the group table at 434. The group table at 434 may include an entry for each member that has joined the group. For example, the group table at 434 may include an entry corresponding to UE1 402 and an entry corresponding to UE2 404. Each entry may include the name of the group (e.g., officeGroup), the HoA corresponding to the entry, the known binding identifier associated with each entry (e.g., if binding identifier is unknown this may be indicated in the group table), the HA IP address corresponding to the entry, and/or the UE type corresponding to the entry (e.g., phone or laptop).

SC 410 may send a JOIN group request message 436 to HA2 408 that indicates that another member has joined the group to which UE2 404 is a member. The JOIN group request message 436 may include parameters indicating that another member joined the group, the name of the group (e.g., officeGroup), an HoA associated with the UE that joined the group (e.g., HoA1), an HA IP address associated with the UE that joined the group (e.g., HA1 IP), and/or a UE type associated with the UE that joined the group (e.g., phone).

After HA2 408 receives the JOIN group request message 436, HA2 408 may update its group table at 438. For example, HA2 408 may add an entry corresponding to UE1 402 to the group table at 438. The group table at 438 may include an entry for each member that has joined the group. For example, the group table at 438 may include an entry corresponding to UE1 402 and an entry corresponding to UE2 404. Each entry may include the name of the group (e.g., officeGroup), the HoA corresponding to the entry, the known binding identifier associated with the entry (e.g., if binding identifier is unknown this may be indicated in the group table), the HA IP address corresponding to the entry, and/or the UE type corresponding to the entry (e.g., phone or laptop).

FIG. 4B is a flow diagram illustrating an SC adding a UE to a group. As illustrated in FIG. 4B, at 440 SC 410 knows that UE1 402 and UE2 404 have joined the officeGroup and that UE2 404 has also joined a group called “newGroup.” The UE2 404 may have joined the newGroup using methods described herein for adding and/or joining a group. As UE2 404 has joined newGroup, HA1 may updates its group table at 442, SC 410 may update its group table at 444, and HA2 408 update its group table at 446. The group tables may be updated as described herein to reflect the addition of the newGroup entry.

At 448, SC 410 may add UE1 402 to the newGroup. The SC 410 may send the JOIN information to the HAs that are serving UEs registered to the newGroup. For example, SC 410 may send a JOIN group request message 450 to HA1 406. The JOIN group request message 450 may include parameters indicating that a member has been joined to a group, the name of the group (e.g., newGroup), an HoA associated with the UE that has been joined to the group (e.g., HoA1), an HA IP address associated with the UE that has been joined to the group (e.g., HA1 IP), and/or a UE type associated with the UE that has been joined to the group (e.g., phone). The HA1 406 may send a JOIN group request message 452 to the UE1 402. The JOIN group request message 452 may include parameters indicating that a member has been joined to a group, the name of the group (e.g., newGroup), an HoA associated with the UE that has been joined to the group, an HA IP address associated with the UE that has been joined to the group, and/or a UE type associated with the UE that has been joined to the group (e.g., phone). UE1 402 may store the group information locally at 456.

SC 410 may also send a JOIN group request message 454 to HA2 408. The JOIN group request message 454 may include parameters indicating that a member has been joined to a group, the name of the group (e.g., newGroup), an HoA associated with the UE that has been joined to the group, an HA IP address associated with the UE that has been joined to the group, and/or a UE type associated with the UE that has been joined to the group (e.g., phone).

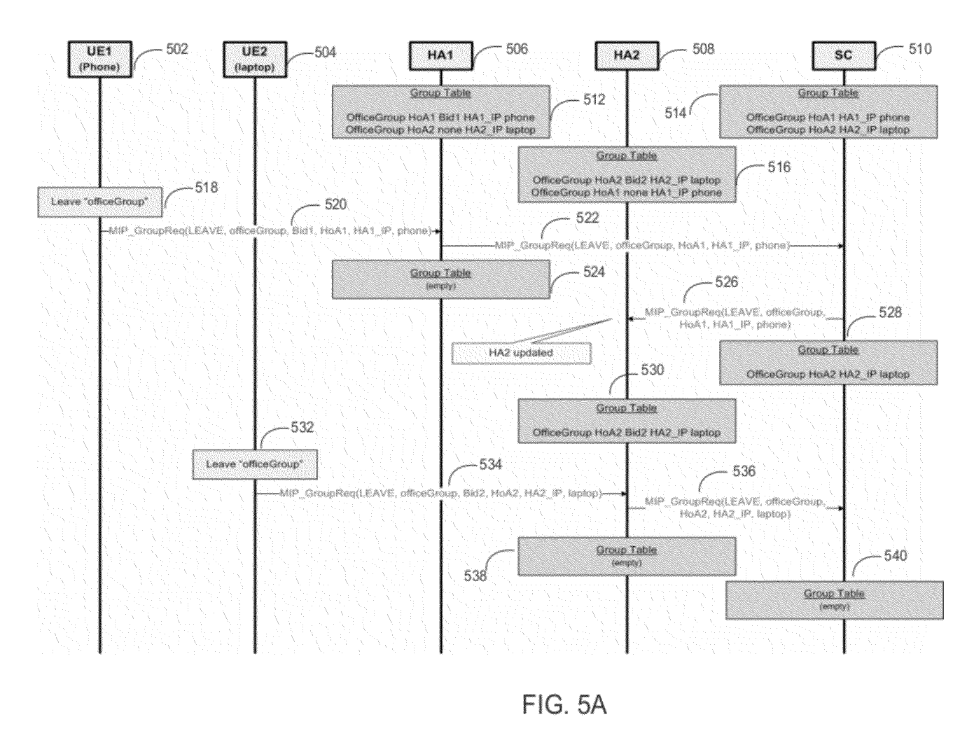

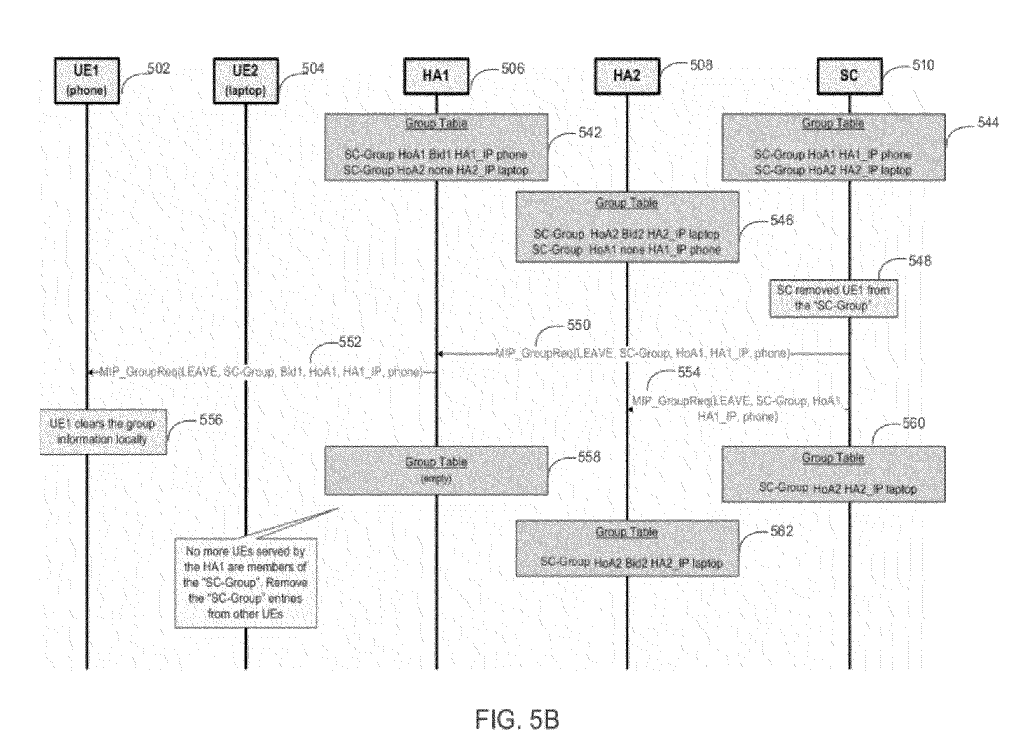

FIGS. 5A and 5B illustrate an example of a UE leaving a group. In an example, the user may dynamically remove the UE from a group. A request to leave the group, such as a LEAVE group request for example, may be sent to the SC and/or the HA associated with a member of the group. The UE may also clear the associated membership entry for that group.

The HA may send a request to leave a group, such as a LEAVE group request, to remove a UE from a group. For example, if a UE fails to renew its MIP registration, the UE may be considered as “not available anymore.” A LEAVE group request may be sent by the HA to the SC, on behalf of the UE. The HA may also receive a request to leave a group, such as a LEAVE group request. For example, the HA may receive a LEAVE group request from a UE served by the HA. The HA may send the request to the SC. The SC may propagate the request to the HAs that may have at least one UE registered to the group. If there is no SC used in the network, the LEAVE request may be directly propagated to the other HAs. In an example, the HA may receive a LEAVE group request associated with a UE from the SC. If the UE is served by the HA, the LEAVE request may be forwarded to the concerned UE. The UE may be removed from the group table. If no more UEs served by the current HA are members of this group, the UEs served by other HAs may be removed from the group table.

The SC may receive a request to leave a group, such as a LEAVE Group request. For example, the LEAVE message may be forwarded to the HA's that may have at least one UE registered to the group. The UE entry may be removed from the group table. The SC may also send a request to leave a group, such as a LEAVE Group request, to remove a UE from the group. The SC may dynamically remove a UE from a group that the SC may have created. The LEAVE message may be forwarded to the serving HA and to the HA's that may have at least one UE registered to the group.

FIG. 5A is a flow diagram illustrating a UE removing itself from a group. As illustrated in FIG. 5A, HA1 506, HA2 508, and SC 510 each include a group table, at 512, 516, and 514 respectively, that include an entry for each of the two UEs that are a member of the group entitled “officeGroup.” At 518 the UE1 502 may decide to leave the officeGroup. For example, an indication to leave the officeGroup may be received from a user, a network operator, and/or another entity interested in configuring groups within a network. The UE1 502 may send a LEAVE group request message 520 to HA1 506, which may be the HA serving the UE1 502 for example. The LEAVE group request message 520 may include parameters indicating that a member of a group wants to leave the group, the name of the group (e.g., officeGoup), a binding identifier associated with the UE that wants to leave the group, an HoA associated with the UE that wants to leave the group, an HA IP address associated with the UE that wants to leave the group, and/or a UE type associated with the UE that wants to leave the group (e.g., phone). After HA1 506 receives LEAVE group request message 520, HA1 506 may remove the entry corresponding to UE1 502 from its group table at 524.

The HA1 506 may send a LEAVE group request message 522 to SC 510. The LEAVE group request message 522 may include parameters indicating that a member of a group wants to leave the group, the name of the group (e.g., officeGoup), an HoA associated with the UE that wants to leave the group, an HA IP address associated with the UE that wants to leave the group, and/or a UE type associated with the UE that wants to leave the group (e.g., phone). After SC 510 receives LEAVE group request message 522, SC 510 may remove the entry corresponding to UE1 502 from its group table at 528.

The SC 510 may send a LEAVE group request message 526 to HA2 508 to notify HA2 508 that UE1 has left the officeGroup. The LEAVE group request message 526 may include parameters indicating that a member of a group wants to leave the group, the name of the group (e.g., officeGoup), an HoA associated with the UE that wants to leave the group, an HA IP address associated with the UE that wants to leave the group, and/or a UE type associated with the UE that wants to leave the group (e.g., phone). The LEAVE group request message may be sent to HA2 508 so that HA2 508 may update its group table to remove the entry corresponding to UE1 502. At 530, HA2 508 may remove the entry corresponding to UE1 502 from its group table.

At 532, UE2 504 may also decide to leave the officeGroup. For example, UE2 504 may receive an indication from a user, a network operator, and/or another entity interested in configuring groups within a network. The UE2 504 may send a LEAVE group request message 534 to HA2 508, which may be the HA serving the UE2 504 for example. The LEAVE group request message 534 may include parameters indicating that a member of a group wants to leave the group, the name of the group (e.g., officeGoup), a binding identifier associated with the UE that wants to leave the group, an HoA associated with the UE that wants to leave the group, an HA IP address associated with the UE that wants to leave the group, and/or a UE type associated with the UE that wants to leave the group (e.g., laptop). After HA2 508 receives LEAVE group request message 534, HA2 508 may remove the entry corresponding to UE2 504 from its group table at 538. After UE1 502 and UE2 504 have been removed from the group table, the group table may be empty.

The HA2 506 may send a LEAVE group request message 536 to SC 510. The LEAVE group request message 536 may include parameters indicating that a member of a group wants to leave the group, the name of the group (e.g., officeGoup), an HoA associated with the UE that wants to leave the group, an HA IP address associated with the UE that wants to leave the group, and/or a UE type associated with the UE that wants to leave the group (e.g., laptop). After SC 510 receives LEAVE group request message 536, SC 510 may remove the entry corresponding to UE2 504 from its group table at 540. After UE1 502 and UE2 504 have been removed from the group table, the group table may be empty.

FIG. 5B is a flow diagram illustrating an SC removing a UE from a group. SC 510 may remove members of a group that were added by the SC and/or members of a group that were added by another entity on the network (e.g., UE). As illustrated in FIG. 5B, HA1 506, HA2 508, and SC 510 each have a group table, at 542, 546, and 544 respectively, that includes two entries. One entry indicates that UE1 502 is a member of a group entitled “SC-Group,” while the other entry indicates that UE2 504 is a member of the SC-Group.

At 548, SC 510 removes UE1 from the SC-Group. SC 510 may remove the entry associated with UE1 502 from its group table at 560. SC 510 may send a LEAVE group request message 550 to HA1 506 indicating that UE1 is removed from the SC-Group. The LEAVE group request message 550 may include parameters indicating that a member of a group has been removed from the group, the name of the group (e.g., SC-Group), an HoA associated with the UE that has been removed from the group, an HA IP address associated with the UE that has been removed from the group, and/or a UE type associated with the UE that has been removed from the group (e.g., phone). After HA1 506 receives LEAVE group request message 550, HA1 506 may remove the entry corresponding to UE1 504 from its group table at 558. After UE1 502 has been removed from the group table at 558, the group table may be empty because no more UEs served by HA1 506 may be members of the SC-Group.

After UE1 502 has been removed from the SC-Group, the SC-Group entries may be removed from UE1 502. For example, HA1 506 may send a LEAVE group request message 552 to UE1 502. The LEAVE group request message 552 may include parameters indicating that a member of a group has been removed from the group, the name of the group (e.g., SC-Group), a binding identifier associated with the UE that has been removed from the group, an HoA associated with the UE that has been removed from the group, an HA IP address associated with the UE that has been removed from the group, and/or a UE type associated with the UE that has been removed from the group (e.g., phone). At 556, UE1 502 may clear the SC-Group information locally.

SC 510 may also send LEAVE group request message 554 to HA2 508 so that HA2 508 may update its group table. The LEAVE group request message 554 may include parameters indicating that a member of a group has been removed from the group, the name of the group (e.g., SC-Group), an HoA associated with the UE that has been removed from the group, an HA IP address associated with the UE that has been removed from the group, and/or a UE type associated with the UE that has been removed from the group (e.g., phone). HA2 508 may remove the entry associated with UE1 502 from its group table at 562. The group table at 562 may still include the entry associated with UE2 504 in the SC-Group, as UE2 504 remains a member of the SC-Group and HA2 508 is serving UE2 504.

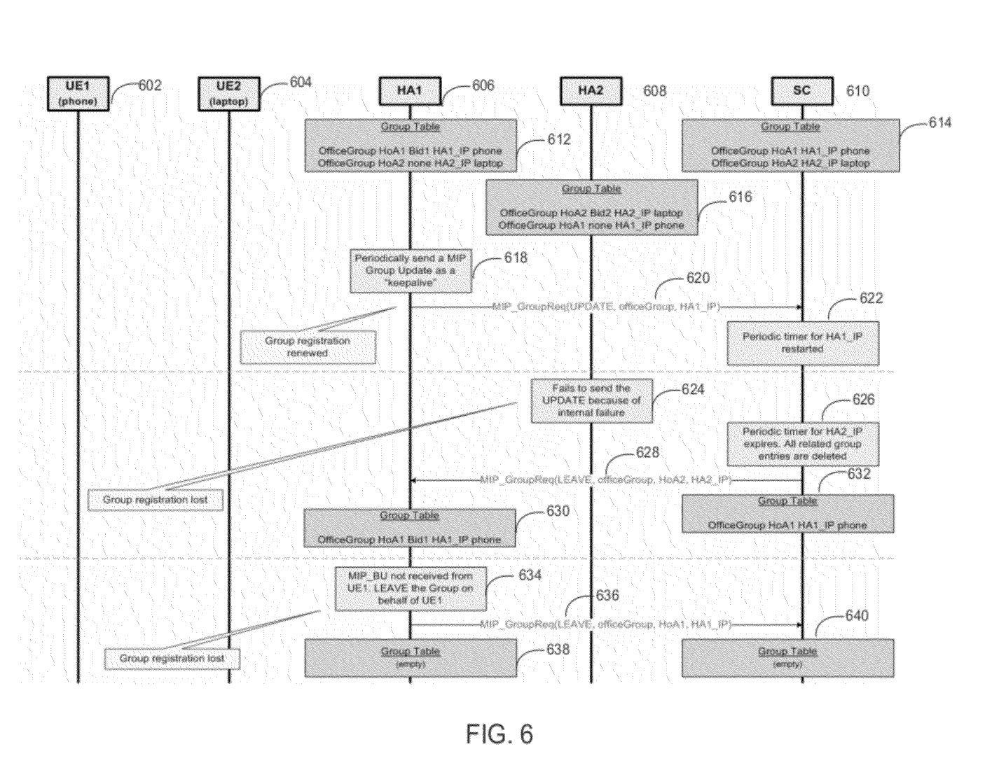

FIG. 6 is a flow diagram illustrating the use of a group update message to manage UEs included in a group. The HA may send a group update message, such as an UPDATE group request message for example. An UPDATE group message may be sent periodically to the SC as a “keepalive.” For example, not sending the UPDATE group message may result in the SC deleting all entries from the specific HA. The group update messages may be sent at a predetermined interval.

The SC may receive a group update message such as an UPDATE group message. An UPDATE group message may be sent periodically to the SC as a “keepalive.” In an embodiment, if no update messages are received from an HA that may have at least one UE registered to at least one group, the UEs from that HA may be considered to have “left the group.” Indications may be sent to the other HAs such that the other HAs may update the local group table (the UEs may be considered as “not available” and may be removed from the table).

As illustrated in FIG. 6, HA1 606, HA2 608, and SC 610 each have a group table, at 612, 616, and 614 respectively, that includes two entries. One entry indicates that UE1 602, which is served by HA1 606, is a member of a group entitled “officeGroup,” while the other entry indicates that UE2 604, which is served by HA2 608, is a member of the officeGroup. HA1 606 may be configured at 618 to send a periodic UPDATE group request message as a “keepalive” message to keep UE1 602 included in the officeGroup by renewing its group registration. HA1 606 may send UPDATE group request message 620 to SC 610. The UPDATE group request message 620 may include parameters indicating that a member of a group would like to update their registration to the group, the name of the group (e.g., officeGroup), and/or an HA IP address associated with the UE that would like to update their registration to the group. After receiving the UPDATE group request message 620, the SC 610 may restart a periodic timer at 622 that is set for removing the UE1 602 from the officeGroup upon expiration.

At 624, HA2 608 fails to send an UPDATE group request message. For example, the failure to send the message may be due to an internal failure at the HA2 608. As a result, the group registration for UE2 604, which is served by HA2 608, may be lost. At 626, the periodic timer associated with HA2 608 may expire and all group entries related to HA2 608 may be deleted. For example, the SC 610 may remove the officeGroup entry corresponding to the UEs being served by HA2 608 from the group table at 632. SC 610 may send a LEAVE group request message 628 to HA1 606, which may enable HA1 606 to update its group table at 630 to remove the officeGroup entry corresponding to UE2 604 from the group table. The LEAVE group request message 628 may include parameters indicating that a member of a group has been removed from the group (e.g., LEAVE parameter), the name of the group (e.g., officeGroup), an HoA associated with the UE that has been removed from the group, and/or an HA IP address associated with the UE that has been removed from the group.

At 634, the HA1 606 may not receive an indication from UE1 602 to stay in the group and may determine that it should leave the officeGroup on behalf of UE1 602. Once the HA1 606 determines to leave the officeGroup, the group registration may be lost. The HA1 606 may then remove the entry in its group table corresponding to UE1 602 at 638. The HA1 606 may send a LEAVE group request message 636 to the SC 610, so that the SC 610 may update its group table at 640. The LEAVE group request message 636 may include parameters indicating that a member of a group has been removed from the group (e.g., LEAVE parameter), the name of the group (e.g., officeGroup), an HoA associated with the UE that has been removed from the group, and/or an HA IP address associated with the UE that has been removed from the group.

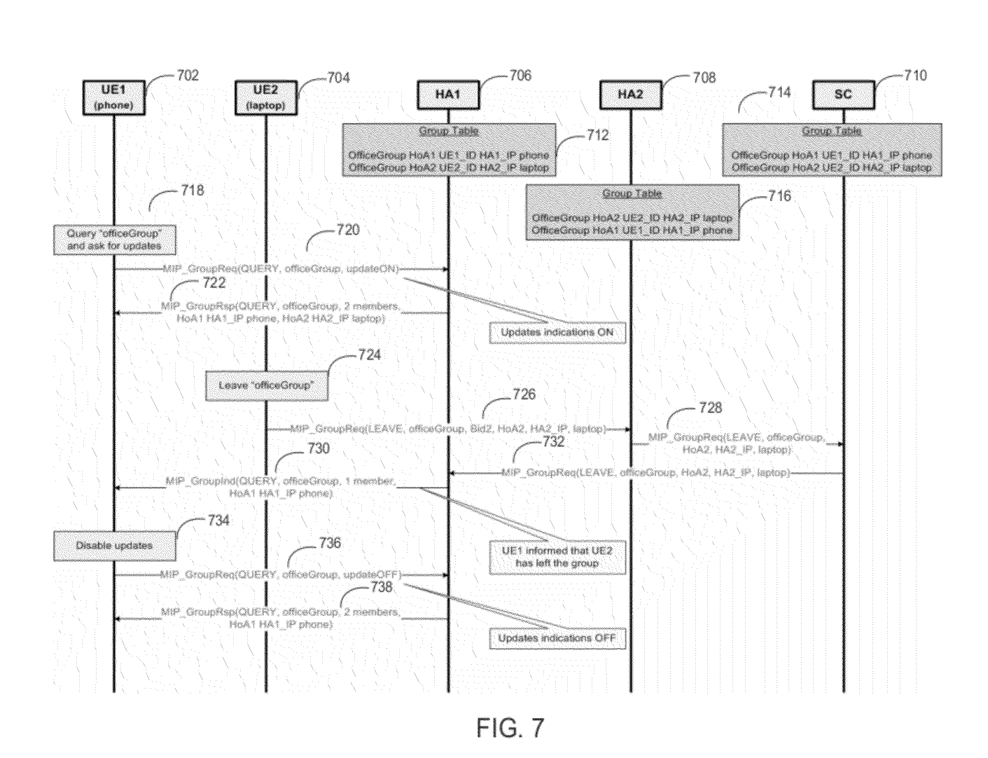

FIG. 7 is a flow diagram illustrating the use of a QUERY group request message. The UE may send a query group request such as a QUERY group request to query information related to a specific group. For example, the UE may want to know the list of UEs that may be registered in a specific group. The UE may receive a query group response or indication. The UE may pass the received information to the running application that may react based on received information.

In an embodiment, the HA may receive a request, such as a QUERY group request for example, to query group information. The HA may send a QUERY response message including one or more entries associated to the specified group identifier.

As illustrated in FIG. 7, HA1 706, HA2 708, and SC 710 each include a group table, at 712, 716, and 714 respectively, that includes two entries. One entry indicates that UE1 702, which is served by HA1 706, is a member of a group entitled “officeGroup,” while the other entry indicates that UE2 704, which is served by HA2 708, is a member of the officeGroup.

At 718, UE1 702 decides to query the officeGroup and/or ask for updates. The UE1 702 may send a QUERY group request message 720 to HA1 706. The QUERY group request message 720 may include parameters indicating the type of message (e.g., QUERY message), the name of the group (e.g., officeGroup), and/or that an update indication is turned on. HA1 706 may send QUERY group response message 722 to UE1 702. The QUERY group response message 722 may include parameters indicating the type of message (e.g., QUERY message), the name of the group (e.g., officeGroup), the number of members in the group (e.g., 2 members), an HoA associated with each UE that is a member of the group, an HA IP address associated with each UE that is a member of the group, and/or a UE type for each UE that is a member of the group (e.g., phone or laptop).

At 724, the UE2 704 may leave the officeGroup. UE2 704 may send a LEAVE group request message 726 to the HA2 708. The LEAVE group request message 726 may include parameters indicating that a member of a group is leaving the group (e.g., LEAVE parameter), the name of the group (e.g., officeGroup), a binding identifier associated with the member leaving the group, an HoA associated with the member leaving the group, an HA IP address associated with the member leaving the group, and/or a UE type associated with the member leaving the group (e.g., laptop).

The HA2 708 may send a LEAVE group request message 728 to the SC 710. The LEAVE group request message 728 may include parameters indicating that a member of a group is leaving the group (e.g., LEAVE parameter), the name of the group (e.g., officeGroup), an HoA associated with the UE that is leaving the group, an HA IP address associated with the UE that is leaving the group, and/or a UE type associated with the UE that is leaving the group (e.g., laptop). The SC 710 may send a LEAVE group request message 732 to the HA1 706. The LEAVE group request message 732 may include parameters indicating that a member of a group is leaving the group (e.g., LEAVE parameter), the name of the group (e.g., officeGroup), an HoA associated with the UE that is a member of the group, an HA IP address associated with the UE that is a member of the group, and/or a UE type associated with the UE that is a member of the group (e.g., laptop).

The HA1 706 may send a QUERY group indication message 730 to UE1 702 that may indicate to UE1 702 that UE2 has left the group. The QUERY group indication message may include parameters indicating the type of message (e.g., QUERY message), the name of the group (e.g., officeGroup), the number of members in the group (e.g., 1 member), an HoA associated with the UE that is a member of the group, an HA IP address associated with the UE that is a member of the group, and/or a UE type associated with the UE that is a member of the group (e.g., phone).

At 734, the UE1 702 may disable group updates. For example, the UE1 702 may disable group updates when it is the last member left in a group. The UE1 702 may send a QUERY group request message 736 to HA1 706. The QUERY group request message 736 may include parameters indicating the type of message (e.g., QUERY message), the name of the group (e.g., officeGroup), and/or an indication to turn updates off. HA1 706 may send a QUERY group response message 738 to UE1 702. The QUERY group response message 738 may include parameters indicating the type of message (e.g., QUERY message), the name of the group (e.g., officeGroup), the number of members in the group, an HoA associated with the UE that is a member of the group, an HA IP address associated with the UE that is a member of the group, and/or a UE type associated with the UE that is a member of the group (e.g., phone).

In an embodiment, the UE may send a data request such as a DATA group request to obtain information from one or more members in the group. For example, an application running on the UE may send application layer information to a specific group of UEs. The data message may be sent to the serving HA. The HA may duplicate and send the data message to the other members of the group that the HA may be serving. The HA may also send the data message to the SC when some members are registered with other HAs.

An HA may receive a data request, such as a DATA group request for example. The data may be duplicated and/or may be sent to registered UEs, for example, using unicast messages (CoAs). In an embodiment, the MIP header may be removed from the data. The message may be forwarded to the SC if at least one UE that may be a member of the group is not served by the current HA (e.g. no Binding ID). The SC may forward the message to the appropriate HAs that may de-encapsulate the message and send the message to group member UEs that the HAs may serve.

The HA may receive a data request, such as a DATA group request. The data may be duplicated and may be sent to registered UEs, for example, using unicast messages (CoAs). The SC may forward the message to the HA's that may have at least one UE registered to the group. The SC may also send a data request such as a DATA Group request. The SC may send data to a group. The data include information that enables an IUT or transfer of media flow between UEs for example. The message may be sent to the HAs that are serving UEs registered to the group. HAs may take care of duplicating and sending the data to the members of the group that they are serving.

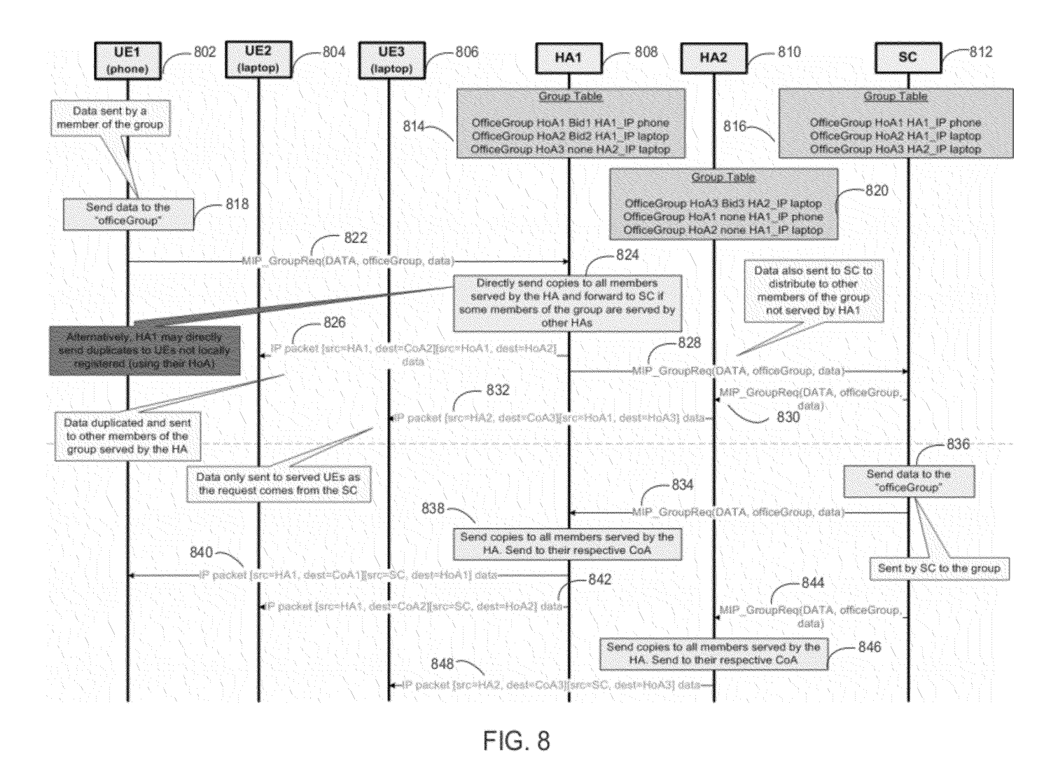

FIG. 8 is a flow diagram illustrating the use of a DATA group request. As illustrated in FIG. 8, HA1 808, HA2 810, and SC 812 each have a group table, at 814, 820, and 816 respectively, that includes three entries. One entry indicates that UE1 802, which is served by HA1 808, is a member of a group entitled “officeGroup,” the second entry indicates that UE2 804, which is served by HA1 808, is a member of the officeGroup, and the third entry indicates that UE3 806, which is served by HA2 810, is a member of the officeGroup.

At 818, UE1 802 may decide to send data to the members of the officeGroup. For example, UE1 802 may send a DATA group request message 822 to HA1 808. The DATA group request message 822 may include parameters indicating the type of message (e.g., DATA message), the name of a group (e.g., officeGroup), and/or the data to be sent to the members of the group. HA1 808 may send the data to members served by HA1 808 and/or forward the data to SC 812 if some members of the group are served by another HA, such as HA2 810 for example. Alternatively, HA1 808 may send the data to a UE that is not locally registered, such as UE3 806 for example. For example, the HA1 808 may send data to a UE that is not registered to HA1 808 using the HoA associated with the UE.

HA1 808 may send the data directly to other members of the group served by HA1 808. For example, HA1 808 may send the data received from UE1 802 to UE2 804. The data may be sent using IP packet 826 for example. IP packet 826 may include parameters indicating the source of the IP packet 826 (e.g., HA1 808), the destination of the IP packet 826 (e.g., CoA2), the source of the data (e.g., HoA1), the destination of the data (e.g., HoA2), and/or the data itself.

HA1 808 may send data to the SC 812 to distribute to other members of the group not served by HA1 808. For example, HA1 808 may send a DATA group request message 828 to SC 812. The DATA group request message may include parameters indicating the type of message (e.g., DATA message), the name of the group (e.g., officeGroup), and/or the data to be sent to other members of the group. SC 812 may forward the data to an HA serving another UE in the group. For example, SC 812 may send a DATA group request message 830 to HA2 810. The DATA group request message 830 may include parameters indicating the type of message (e.g., DATA message), the name of the group (e.g., officeGroup), and/or the data to be sent to other members of the group. The HA2 810 may send the data to UE3 806. For example, the HA2 810 may send IP packet 832 to UE3 806. IP packet 832 may include the source of the IP packet (e.g., HA2), the destination of the IP packet (e.g., CoA3), the source of the data (e.g., HoA1), the destination of the data (e.g, HoA3), and/or the data itself. The data may be sent to the served UEs when the request comes from the SC 812.

Data may also originate and/or be originally sent through the SC 812. For example, SC 812 may determine to send data to the officeGroup at 836. The SC 812 may send a DATA group request message 834 to HA1 808 and/or a DATA group request message 844 to HA2 810. HA1 808 may decide to send the data to members served by HA1 808 at 838. For example, HA1 808 may send data to the members served by HA1 808 by using their respective CoA. HA1 808 may then send IP packet message 840 to UE1 802 and IP packet message 842 to UE2 804. IP packets 840 and 842 may include the source of the IP packet (e.g., HA1), the destination of the IP packet (e.g., CoA1 or CoA2), the source of the data (e.g., SC 812), the destination of the data (e.g, HoA1 or HoA2), and/or the data itself. The data may be sent to the served UEs when the request comes from the SC 812. HA2 810 may also decide to send the data to the members served by HA2 810. For example, HA2 810 may send data to UE3 806 using the CoA3 corresponding to UE3 806. The HA2 810 may send an IP packet message 848 to UE3 806. The IP packet message may include the source of the IP packet (e.g., HA2), the destination of the IP packet (e.g., CoA3), the source of the data (e.g., SC 812), the destination of the data (e.g, HoA3), and/or the data itself.

The data that is sent between UEs in a group may include information that enables an IUT or transfer of media flow between UEs for example.

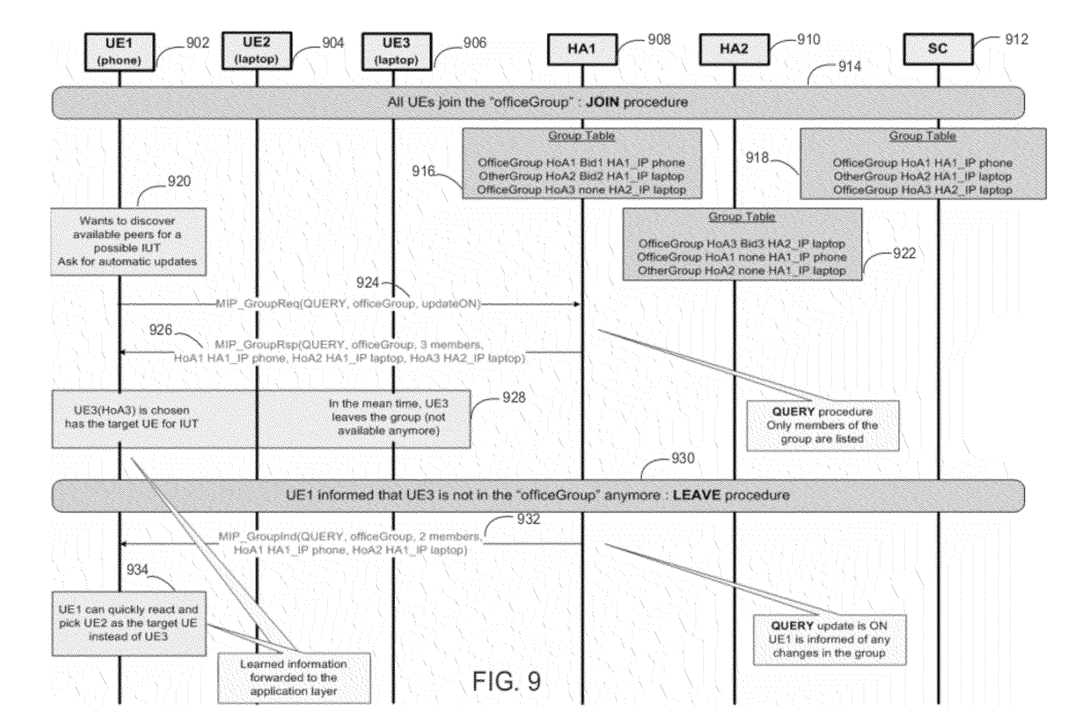

FIG. 9 illustrates an example IUT peer discovery process using MIP group functionality. Peer discovery may be part of the IUT procedure. Before being able to initiate an IUT, the available peers may be discovered. Peer discovery may be done using MIP protocol with the addition of the MIP group functionality. Groups may be pre-configured, defined dynamically by the users or defined dynamically by the network. For example, UEs belonging to a single subscriber may be pre-configured into a group (e.g., “subscriberGroup”). UEs from the office may be added dynamically to a different group (e.g., officeGroup including colleagues' laptop, video conference systems, etc). For example, the network may form a group dynamically (e.g., to group together UEs that are very active, to propagate contract offers, etc).

As illustrated in FIG. 9, Home Agents (HAs) may be aware of available UEs, such as via MIP registration for example. In an embodiment, the HAs may facilitate peer discovery in preparation for IUT. UEs may be grouped for IP flow transfer and/or sharing. Each UE may be associated with one or more groups (e.g., myHouseGroup, myOfficeGroup, or myFriendsGroup).

As illustrated in FIG. 9, UE1 902, UE2 904, and UE3 906 may join a group entitled officeGroup at 914, using the JOIN procedure as described herein for example. HA1 908, HA2 910, and SC 912 each have a group table, at 916, 922, and 918 respectively, that includes three entries. One entry indicates that UE1 902, which is served by HA1 908, is a member of the officeGroup, the second entry indicates that UE2 904, which is served by HA1 908, is a member of the officeGroup, and the third entry indicates that UE3 906, which is served by HA2 910, is a member of the officeGroup.

At 920, UE1 902 may want to discover available peers for a possible IUT and/or may ask for automatic updates. UE1 902 may send a QUERY group request 924 to HA1 908. The QUERY group request 924 may include parameters indicating the type of message (e.g., QUERY message), the name of the group (e.g., officeGroup), and/or an indication to turn on the update procedure (e.g., updateON). In response to the QUERY group request 924, members of the group may be sent to the UE1 902. For example, HA1 908 may send a QUERY group response message 926 to the UE1 902. QUERY group response message 926 may include parameters indicating the type of message (e.g., QUERY message), the name of the group (e.g., officeGroup), the number of members in the group (e.g., 3 members), the HoA corresponding to each member in the group (e.g., HoA1, HoA2, and HoA3), the HA IP address corresponding to each member in the group (e.g., HA1 IP and HA2 IP), and/or a UE type for each UE that is a member of the group (e.g., phone or laptop).

At 928, UE1 902 may choose UE3 906 may as the target UE for IUT, but UE3 906 may have left the group and/or no longer be available for IUT. Learned information may be forwarded to the application layer. At 930, UE1 902 may be informed that UE3 is not in the officeGroup anymore. For example, UE1 902 may be informed using the LEAVE procedure as described herein. As the QUERY update is on, UE1 902 may be informed of any changes in the group.

HA1 908 may send QUERY group indication message 932 to UE1 902. The QUERY group indication message may include parameters indicating the type of message (e.g., QUERY message), the name of the group (e.g., officeGroup), the number of members in the group (e.g., 2 members), the HoA corresponding to each member in the group (e.g., HoA1 and HoA2), the HA IP address corresponding to each member in the group (e.g., HA1 IP), and/or a UE type for each UE that is a member of the group (e.g., phone or laptop). At 934, UE1 902 may react to UE3 906 leaving the group by selecting UE2 904 as the target UE, instead of UE3 906.

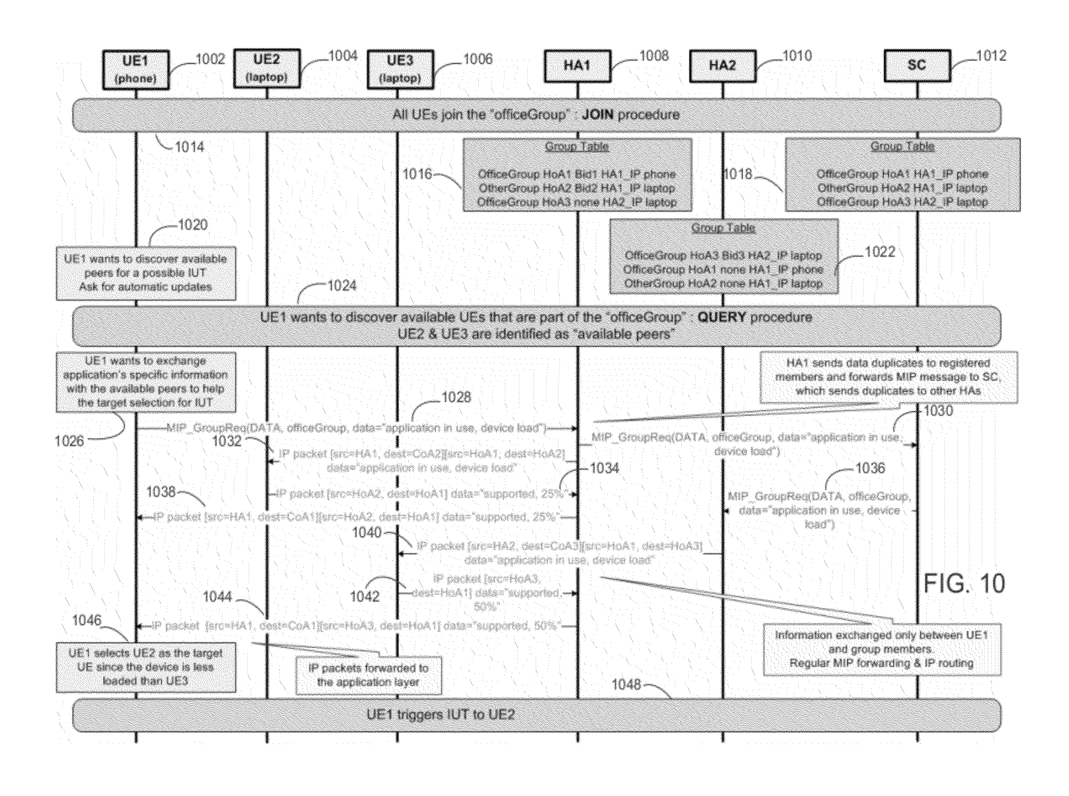

FIG. 10 illustrates an example IUT target peer selection process using MIP group functionality. In an embodiment, the target peer(s) may be selected based on one or more criteria. For example, the selection criteria may include, a supported application (version, equivalent application), current load on the target device, and/or current network conditions (if the application has access to that information).

MIP DATA group functionality may be used to exchange application level information with the discovered peers (e.g., after peer discovery). The request may include, but may not be limited to, one or more of what is the application in use and related information, query about network load, and/or query about load on the device. A response to the request may include, but may not be limited to, one or more of the following: whether the application or an equivalent is supported, version information, current load on the device, and/or current load on the network. The source device initiating the IUT may then select the target peer(s) based on the information received.

The information that may be exchanged using the MIP DATA group mechanism is not limited to what is described herein. With the mechanism for exchanging data between peer members, any kind of information may be exchanged.

As illustrated in FIG. 10, UE1 1002, UE2 1004, and UE3 1006 may join a group entitled officeGroup at 1014, using the JOIN procedure as described herein for example. HA1 1008, HA2 1010, and SC 1012 each have a group table, at 1016, 1022, and 1018 respectively, that includes three entries. One entry indicates that UE1 1002, which is served by HA1 1008, is a member of the officeGroup, the second entry indicates that UE2 1004, which is served by HA1 1008, is a member of the officeGroup, and the third entry indicates that UE3 1006, which is served by HA2 1010, is a member of the officeGroup.

At 1020, UE1 1002 may want to discover available peers for a possible IUT and may ask for automatic updates. At 1024 UE1 1002 may want to discover available UEs that are part of the officeGroup. For example, UE1 1002 may use the QUERY procedure as described herein. UE2 1004 and UE3 1006 may be identified as available peers in the network. UE1 1002 may want to exchange an application's specific information with UE2 1004 and UE3 1006 at 1026 to help the target selection for IUT.

UE1 1002 may send DATA group request message 1028 to HA1 1008. The DATA group request message 1028 may include parameters indicating the type of message (e.g., DATA message), the name of the group (e.g., officeGroup), and/or the data (e.g., “application in use, device load”). HA1 1008 may send the data to registered members of HA1 1008 and/or forward the data to SC 1012, which may send the data to other HAs serving UEs not registered to HA1, such as HA2 1010 for example.

For example, HA1 1008 may send IP packet 1032 to UE2 1004, which is served by HA1 1008. IP packet 1032 may include the source of the IP packet (e.g., HA1), the destination of the IP packet (e.g., CoA2), the source of the data (e.g., HoA1), the destination of the data (e.g, HoA2), and/or the data itself (e.g., “application in use, device load”). The UE2 1004 may respond with an IP packet 1034. IP packet 1034 may include the source of the IP packet (e.g., HoA2), the destination of the IP packet (e.g., HoA1), and/or the data itself (e.g., “supported 25%”).

HA1 1008 may send the data received from UE2 1004 to UE1 1002. For example, HA1 1008 may send IP packet 1038 to UE 1 1002. The IP packet 1038 may include the source of the IP packet (e.g., HA1), the destination of the IP packet (e.g., CoA1), the source of the data (e.g., HoA2), the destination of the data (e.g, HoA1), and/or the data itself (e.g., “supported 25%”).

As described herein, HA1 1008 may send data to SC 1012 to forward the data to other HAs serving other members of the officeGroup. For example, HA1 1008 may send DATA group request message 1030 to SC 1012. The DATA group request message 1030 may include parameters indicating the type of message (e.g., DATA message), the name of the group (e.g., officeGroup), and/or the data (e.g., “application in use, device load”). The SC 1012 may send the data to HA2 1010 using DATA group request message 1036. The DATA group request message 1036 may include parameters indicating the type of message (e.g., DATA message), the name of the group (e.g., officeGroup), and/or the data (e.g., “application in use, device load”).

HA2 1010 may send the data to UE3 1006, which is served by HA2 1010. For example, HA2 1010 may send IP packet 1040 to UE3 1006. IP packet 1040 may include the source of the IP packet (e.g., HA2), the destination of the IP packet (e.g., CoA3), the source of the data (e.g., HoA1), the destination of the data (e.g, HoA3), and/or the data itself (e.g., “application in use, device load”).

After UE3 1006 receives the data from UE1 1002, information may be exchanged between UE3 1006 and UE1 1002. This data exchange may use MIP forwarding and/or IP routing for example. In response to the data received from UE1 1002, UE3 1006 may send data to UE1 1002, via HA1 1008. For example, UE3 1006 may send IP packet 1042 to HA1 1008. IP packet 1042 may include the source of the IP packet (e.g., HoA3), the destination of the IP packet (e.g., HoA1) and/or the data to be sent (e.g., “supported 50%”). HA1 1008 may send the data to UE1 1002 using IP packet 1044. The IP packet 1044 may include the source of the IP packet (e.g., HA1), the destination of the IP packet (e.g., CoA1), the source of the data (e.g., HoA3), the destination of the data (e.g, HoA1), and/or the data itself (e.g., “supported 50%”). The IP packet 1044 may be forwarded to the application layer.

After receiving data from UE2 1004 and UE3 1006, UE1 1002 may select a target UE for IUT or media flow transfer. For example, at 1046, UE1 1002 may select UE2 1004 as the target UE because UE2 1004 is less loaded than UE3 1006. UE1 1002 may then trigger an IUT to UE2 1004.

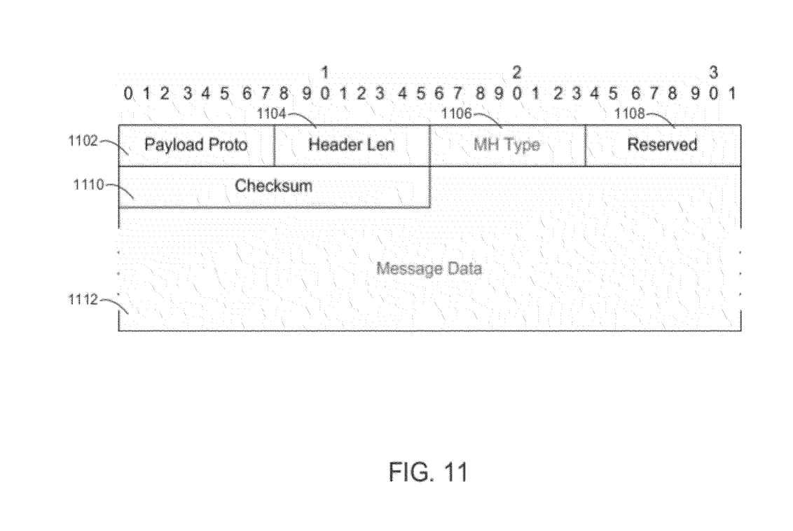

In an embodiment, MIP Protocol may include group messages. FIG. 11 illustrates an example message data field having MIP group extensions. MIP group messages may be exchanged between an SC and an HA and/or between an HA and an HA. The MIP group message may include payload protocol field 1102, header length field 1104, MH type field 1106, reserved field 1108, checksum field 1110, and/or message data field 1112. The MIP messages may be identified by an MH type values such as MIP_GroupReq, MIP_GroupRsp. In an example, there may be no ACK messages for other MIP messages exchange. Rather, a number of retransmission may be executed (e.g. UDP may be used and no response may be received after the transmission of a request). In an embodiment, MIP_BindingUpdate, MIP_BindingAck may be used with the MIP group extensions. In an embodiment, another protocol may be used between an HA and an SC.

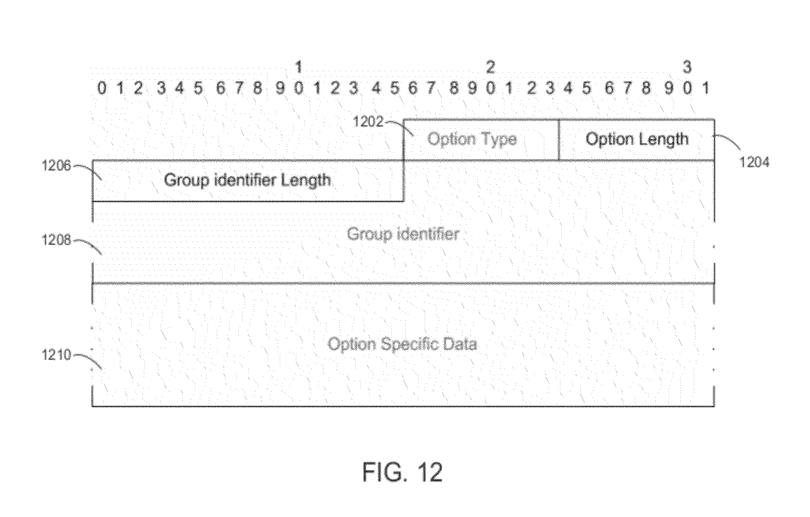

FIG. 12 illustrates an example message data field having MIP group extensions. The message data field may include option type field 1202, option length field 1204, group identifier length field 1206, group identifier field 1208, and/or option specific data field 1210. As shown, the option type field 1202 may represent a request, such as JOIN, UPDATE, QUERY, LEAVE, and/or DATA request. The group identifier field 1208 may include a text string that may uniquely identifying a group (e.g., “My home devices”). Option specific data field 1210 may represent the data associated with each specific request.

Described herein are exemplary option types for the MIP group extensions and examples of the option specific data for each option type. For example, the option types may include a join request, a leave request, a query request, a query response, an update request, and/or a data request. A join request may include a binding identifier, a UE's Home IP Address, a serving HA's IP address, and/or a device description. A leave request may include a UE's Home IP Address, a serving HA's IP address, and/or a device description. A query request may include a flag to request/stop automatic updates. A query response may include a number of group members, a member's Home IP address, a member's HA IP address, and/or a member device description. An update request may include an HA's IP address. A data request may include an application's specific data. Each request also include any other information as described herein. The requests such as join, update, query, leave and/or data may have a corresponding “response” message that may include the status of the request (e.g. success/failure) and/or a request identifier.

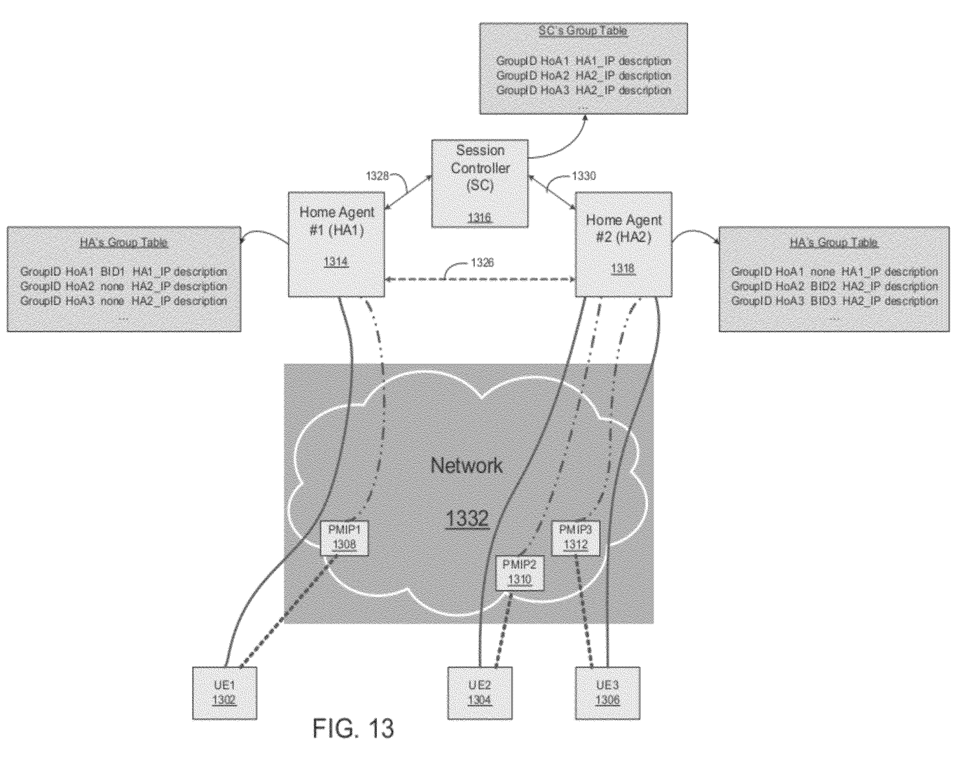

FIG. 13 illustrates an example architecture for group functionality support with proxy MIP implemented in the network. As shown in FIG. 13, IUT protocol may be used between UEs and HAs. Group configuration may be performed using IUT protocol. Proxy MIPs (PMIPs) may be used to indicate UEs presence to the HA (e.g., via MIP registration). For example, proxy MIP1 (PMIP1) 1308 may indicate to HA1 1314 the presence of UE1 1302. Similarly, PMIP2 1310 and PMIP3 1312 may indicate to HA2 1318 the presence of UE2 1304 and UE3 1306 respectively. Each UE may attach to a corresponding PMIP to communicate with an HA and/or communicate directly with the HA, via IUT messages for example. MIP protocol may be used between PMIP1 1308 and HA1 1314, PMIP2 1310 and HA2 1318, and/or PMIP3 1312 and HA2 1318. PMIP 1 1308, PMIP2 1310 and/or PMIP3 1312 may be a part of network 1332, which may be a network used for communication between UEs and HAs. For example, Network 1332 may be the internet.

HA1 1314 may communicate, via 1328, with SC 1316. HA2 1318 may communicate, via 1330, with SC 1316. MIP, IUT, and/or another protocol may be used for communication 1328 and/or communication 1330.

Each UE, HA, and SC may function as described herein with respect to using IUT protocol. In an embodiment, requests such as JOIN, LEAVE, QUERY, and/or DATA requests may be sent from the UE1 1302 to HA 1314 and/or from the UE2 1304 and/or UE3 1306 to HA 1318 using IUT protocol. Communication 1326, between HA1 1314 and HA 1318, may be performed using MIP protocol for example. Communications between HAs and PMIPs and/or UPDATE requests may be performed via MIP protocol.

Peer discovery may be executed using an IUT Protocol that may support the group functionality as described herein. The peer discovery sequence, such as shown in FIG. 9 for example, may exchange IUT messages between the UEs and the HAs in place of MIP messages as illustrated.

Target peer selection may be executed using an IUT Protocol that may support the group functionality as described herein. The target peer selection sequence, such as shown in FIG. 10 for example, may exchange IUT messages between the UEs and the HAs in place of MIP messages as illustrated.

In an embodiment, the IUT protocol may be protocol that supports group functionality. IUT protocol may be a protocol that supports the functionality described herein, including group functionality such as JOIN, LEAVE, QUERY, UPDATE, and/or DATA requests/responses. IUT protocol may support IUT functionality, such as IUT preparation, execution, and/or completion. A combination of protocols may be used together to implement the complete IUT procedures. For example, an application layer protocol may be used to handle information exchange at the application level (e.g., XMPP, H323, sip, etc.) while the IUT procedures may be handled by another protocol (e.g., MIP protocol). In an example, the group functionality may be implemented into a protocol that may be different than the IUT protocol handling the flow transfer and/or replication.

The embodiments described herein may transfer data from one network entity to another using traffic replication transfer. Traffic replication and transfer may be used in a network to enable data to be transmitted to and/or received from multiple destinations, while maintaining a single session. Traffic replication may use a Remote Party, the Session Continuity Controller (SCC), and/or a Media Replication Function (MRF). As described herein, an SCC and an SC may include the same and/or similar functionality.

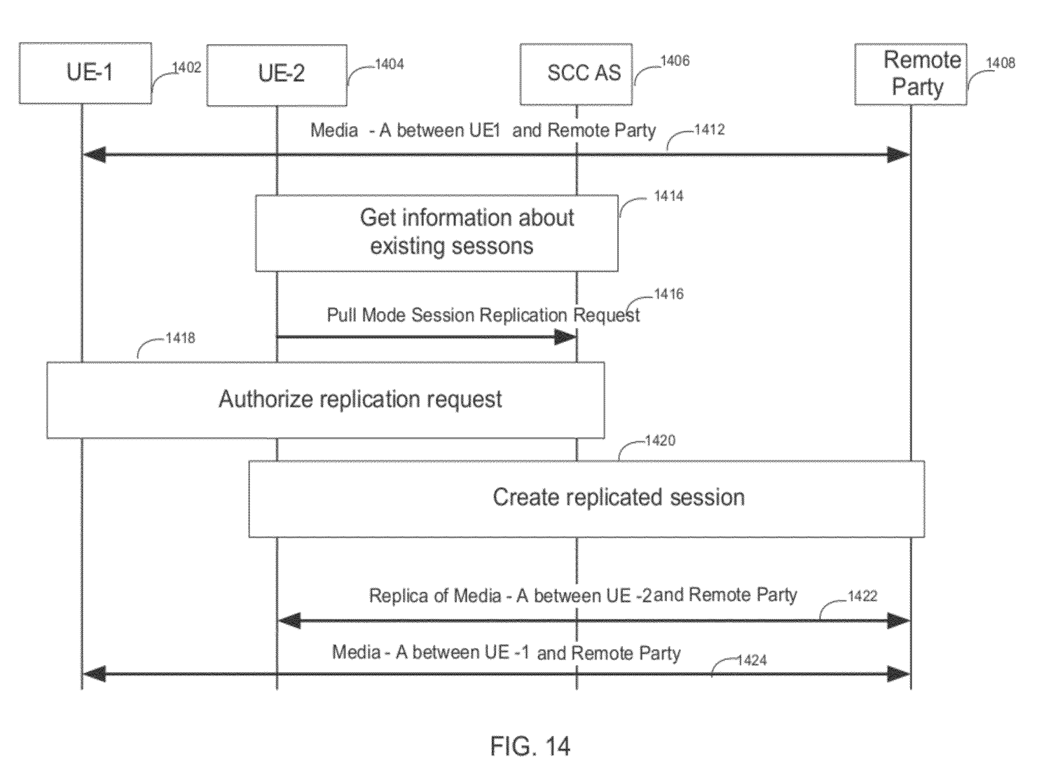

In an embodiment, session replication may be performed by the use of a Remote Party in a pull mode, as illustrated in FIG. 14. A Session Continuity Controller (SCC) may be queried to obtain information about existing sessions and/or their media flows, such as information between a source user equipment (UE) and a Remote Party for example. The SCC may be in charge of obtaining the authorization from the source UE or the SCC may give authority on behalf of the source UE before accepting the replication request.

As illustrated in FIG. 14, at 1412, media-A may be transferred between UE-1 1402 and Remote Party 1408. At 1414, UE-2 1404 and/or SCC 1406 may get information about existing sessions. UE-2 1404 may send a pull mode session replication request to SCC 1406 at 1416. A replication request may be authorized at 1418. A replicated session may be created at 1420. At 1422, a replication of media-A may be sent between UE-2 1404 and Remote Party 1408. At 1424, media-A may be sent between UE-1 1402 and Remote Party 1408.

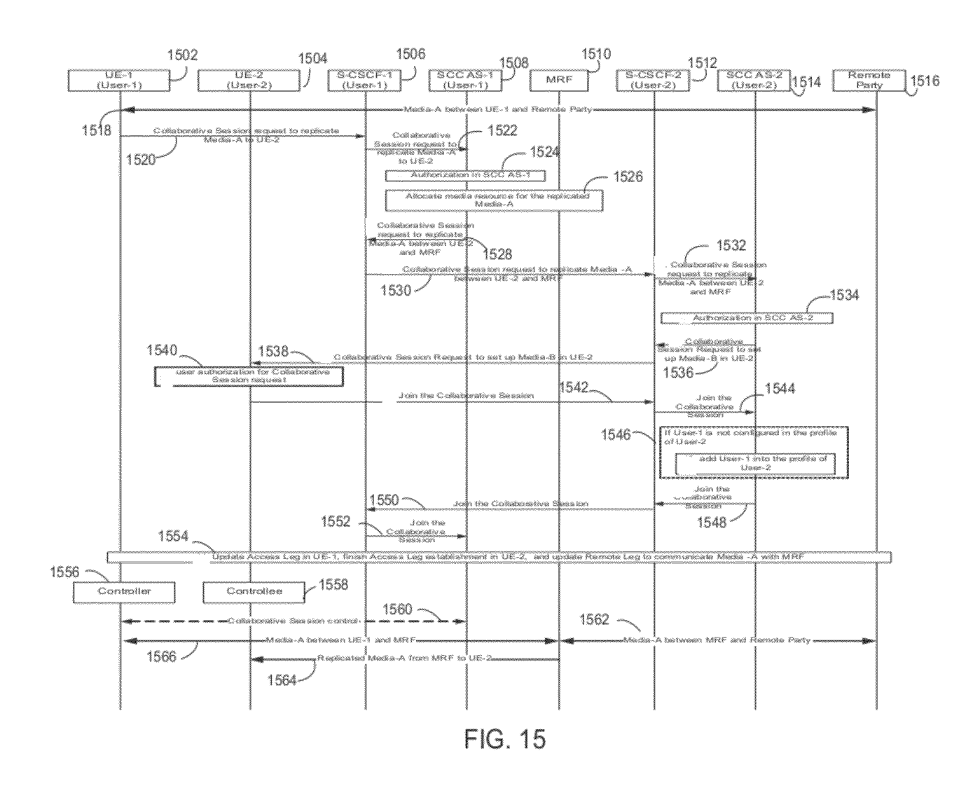

Media flow replication in may be performed by a network in a push mode, as illustrated in FIG. 15. The Controller UE of a Collaborative Session may request that the network replicate a media flow towards another UE that may belong to the same user. The Controller UE may also request that the network replicate a media flow towards a UE that belongs to a second user.

As illustrated in FIG. 15, media-A may be communicated between UE1 1502 and Remote Party 1516 at 1518. UE-1 1502 may send a collaborative session request to replicate media-a to UE-2 1504, via S-CSCF-1 1506 at 1520. A collaborative session request to replicate media-A may be sent from S-CSCF-1 1506 to SCC AS-1 1508 at 1522. SCC AS-1 1508 may perform authorization at 1524 and allocate media resources for the replicated media-A at 1526. At 1528, SCC AS-1 1508 may send a collaborative session request to replicate media-A between UE-2 1504 and MRF 1510 to S-CSCF-1 1506. At 1530, S-CSCF-1 1506 may send the collaborative session request to replicate media-A between UE-2 1504 and MRF 1510 to S-CSCF-2 1512. S-CSCF-2 1512 may send the collaborative session request to replicate media-A between UE-2 1504 and MRF 1510 to SCC AS-2 1514 at 1532. SCC AS-2 1514 may perform authorization at 1534. At 1536, a collaborative session request to set up media-B in UE-2 1504 may be sent to S-CSCF-2 1512 at 1536. At 1538, S-CSCF-2 1512 may send a collaborative session request to set up media-B in UE-2 1504. At 1540, UE-2 1504 may perform user authorization for collaborative session request. UE-2 1504 may send a message, at 1542, to join the collaborative session. S-CSCF-2 1512 may forward the message, at 1544, to join the collaborative session to SCC AS-2 1514. At 1546, if UE-1 1502 is not configured in the profile of UE-2 1504, UE-1 1502 may be added to the profile. SCC AS-2 1514 may send a message to join the collaborative session at 1548. S-CSCF-2 1512 may forward the message, at 1550 to S-CSCF-1 1506, to join the collaborative session. S-CSCF-1 1506 may forward the message to join the collaborative session to SCC AS-1 1508 at 1552. At 1554 the access leg in UE-1 1502 may be updated, establishment of the access leg in UE-2 1504 may be finished, and the remote leg to communicate media-A with MRF 1510 may be updated.

UE-1 1502 may be established as the controller at 1556. UE-2 1504 may be established as the controllee at 1558. At 1560, collaborative session control may be communicated between UE-1 1502 and SCC AS-1 1508. Media-A may be communicated between UE-1 1502 and MRF 1510 at 1566. At 1562, media-A may be communicated between MRF 1510 and remote party 1516. At 1564, media-A may be replicated from MRF 1510 to UE-2 1504.

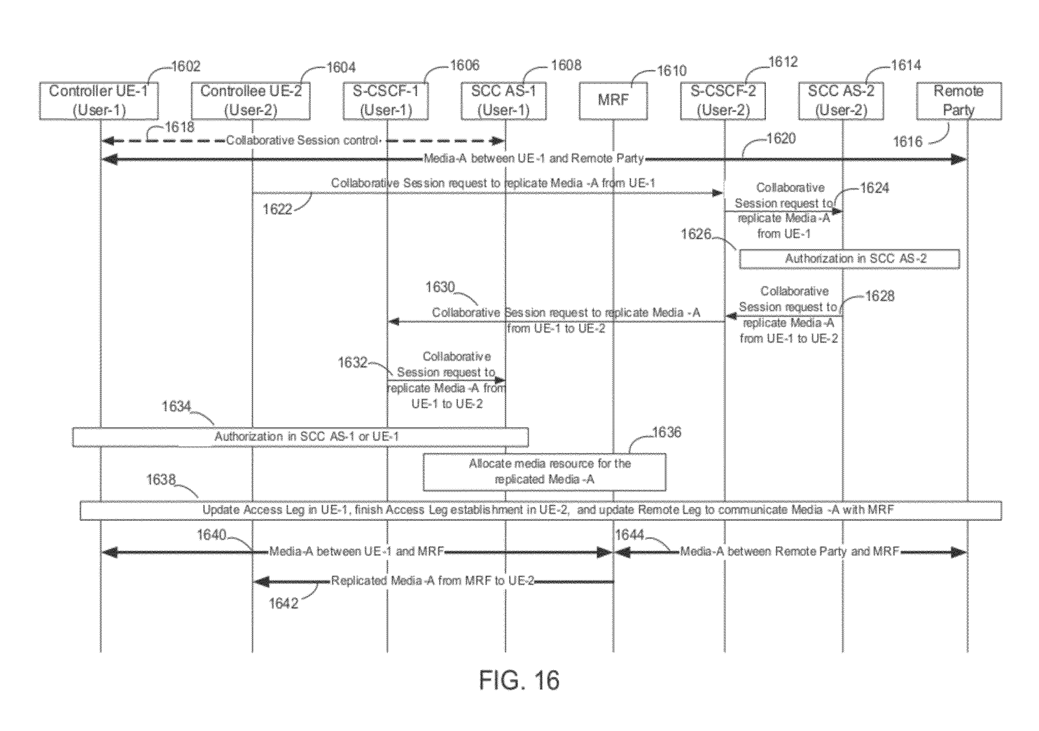

Media flow replication may also be performed by a network in a pull mode, as illustrated in FIG. 16. A UE not participating in the session may request that the network replicate towards itself a media flow that pertains to a UE belonging to the same user. A UE not participating in the session may also request that the network replicate towards itself a media flow that pertains to a UE belonging to another user.

As illustrated in FIG. 16, collaborative session control may be communicated between UE-1 1602 and SCC AS-1 1608 at 1618. At, 1620, media-A may be communicated between UE-1 1602 and Remote Party 1616. At 1622, UE-2 1604 may send a collaborative session request to replicate media-A from UE-1 1602 to S-CSCF-2 1612. S-CSCF-2 1612 may forward the collaborative session request to SCC AS-2 1614 at 1624. SCC AS-2 1614 may perform authorization at 1626. At 1628, SCC AS-2 1614 may send a collaborative session request, to S-CSCF-2 1612, to replicate media-A from UE-1 1602 to UE-2 1604. S-CSCF-2 1612 may forward the collaborative session request to replicate media-A from UE-1 1602 to UE-2 1604 to S-CSCF-1 1606 at 1630. At 1632, S-CSCF-1 1606 may send collaborative session request to replicate media-A to SCC AS-1 1608. At 1634, authorization may be performed in SCC AS-1 1608 and/or UE-1 1602. Media resources may be allocated for the replicated media-A at 1636. At 1638, the access leg in UE-1 1602 may be updated, establishing the access leg in UE-2 1604 may be finished, and/or the remote leg to communication media-A with MRF 1610 may be updated. Media-A may be communicated, at 1640, between UE-1 1602 and MRF 1610. Media-A may be communicated, at 1644, between Remote Party 1616 and MRF 1610. At 1642, media-A may be replicated from MRF 1610 to UE-2 1604.

As described herein, traffic replication may be performed using Mobile IP. Traffic replication and/or transfer in a Mobile IP (MIP) system may be useful to transmit and/or receive data to and/or from multiple destinations, while maintaining a single session in the MIP system. According to one embodiment, flow replication and/or transfer may be enabled in an MIP system using an MIP protocol. For example, MIP messages may be used between a mobile device and a Home Agent (HA). MIP messages may also be used between HAs.

A REPLICATOR may receive data destined to and/or from a source device and may replicate it to target devices. The REPLICATOR may optionally process the data to be sent to the target devices. For example, the REPLICATOR may merge the data from two sources before sending it to another device. The REPLICATOR may be co-located with an HA or a Session Controller.

A Session Controller (SC), which may be similar to a Session Continuity Controller (SCC) in other systems, may handle session configuration with target devices and/or a REPLICATOR. The SC may handle authorization with an Authorization Entity. The SC may handle the communication with other SCs if the target devices are served by different SCs. The SC may be co-located with the HA or the REPLICATOR.

An Authorization Entity (AE) may be used to obtain authorization to execute the replication/transfer to other devices

A data replication mechanism may also be used as a method to accomplish inter-unit transfer (IUT).

A binding table may exist where a Home Address (HoA) may be associated to a single Care-of-Address (CoA). Additionally, the CoA may be updated when a user moves to another location and/or technology.

Dual Stack MIP may allow the registration of one or more internet protocol (IP) addresses and/or prefixes. Dual Stack MIP may also allow the transport of IP packets over a tunnel to an HA. Further, Dual Stack MIP may allow a mobile node to roam over multiple IPs. The use of Multiple Bindings may introduce Binding Identification (BID) mobility extension in Binding Update (BU), and/or Binding Acknowledgement (BA). Multiple Bindings may enable the creation of multiple binding entries on an HA or a Correspondent Node (CN), where one or more CoAs may be associated to a HoA. In Multiple Bindings, a UE may generate a BID for each CoA.

The use of Flow Bindings may include Flow Identification (FID) mobility extension in BU/BA. Flow Bindings may also include flows and may allow a particular flow to bind to one or more CoAs, such as a binding entry. A particular flow may bind to one or more CoAs without affecting other flows using the same HoA. Traffic selectors may be used to identify flows and may be compared with incoming IP packets. The use of Flow Bindings may allow a specification of policies that may be associated with each binding entry. Policies may use traffic selectors. Actions associated with policies may be actions such as delete or forward IP packets to the associated CoA for example.

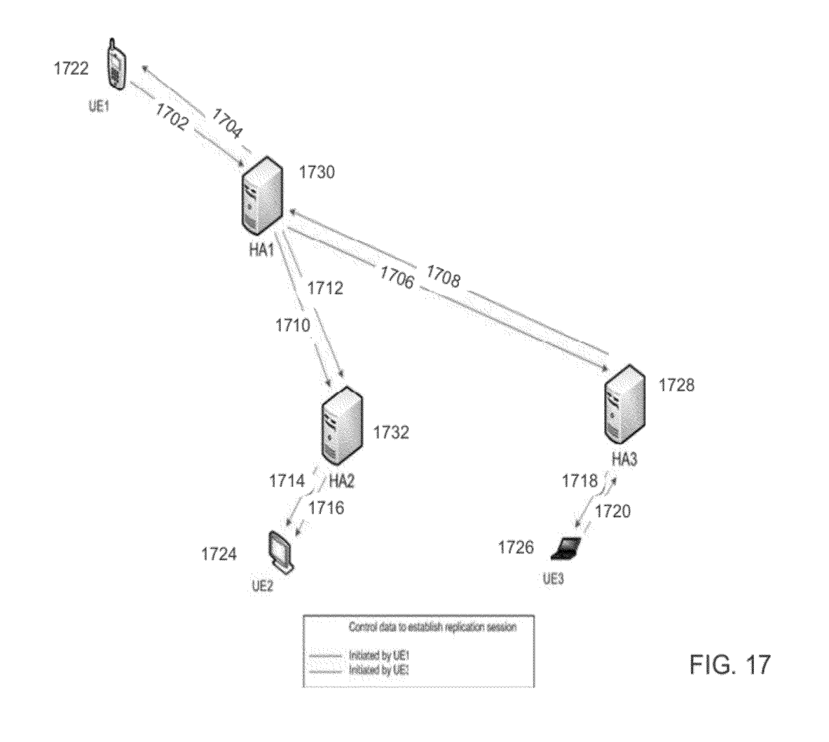

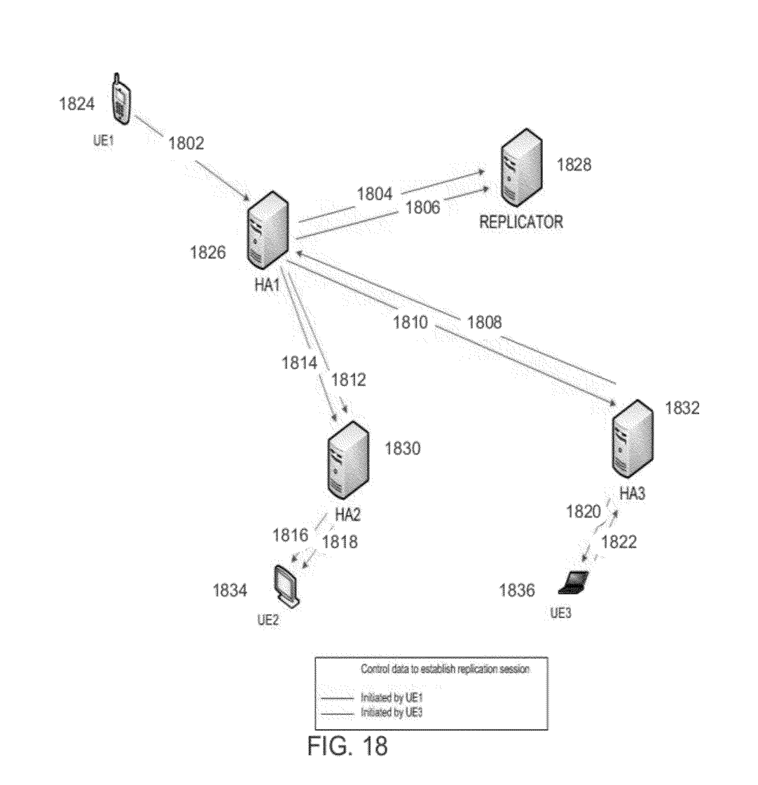

Several operations may be performed to replicate and/or transfer data in an MIP system, such as authorization, session control, and/or data replication for example. Authorization may be handled by an AE or by an HA. Session control may be handled by an SC node, an HA, and/or a REPLICATOR. Data replication may be handled by a REPLICATOR, an HA, and/or an SC. The replicator may have the “intelligence/knowledge” to extract an application's data from a packet and resend it to the destinations over sessions between the REPLICATOR and the destinations, as illustrated in FIGS. 17 and 18 for example.

Many different architecture models are described herein for data replication. Each architectural model described herein may be implemented separately or in combination with another architectural model, or any portion thereof

According to an embodiment, an HA may handle the authorization, the session control, and the replication. For example, an HA may handle the authorization, session control, and/or the data replication in an MIP system in one of two ways. In one example embodiment, a UE may request, via an HA associated with the UE, to replicate a flow towards another UE. In an alternative example embodiment, replication may be triggered by a target UE.

As illustrated in FIG. 17, in the first example, UE1 1722 may make a request at 1704, via HA1 1730, to replicate a flow towards a UE2 1724 and/or a UE3 1726. Authorization may be obtained using pre-configured information. HA1 1730 may send a replication request message, at 1710, to HA2 1732 associated with UE2 1724 and/or, via HA3 1728 associated with UE3 1726. HA2 1732 and HA3 1728 may handle the authorization and may send the request to UE2 1724, at 1714, and/or UE3 1726, at 1718, respectively. UE2 1724 and UE3 1726 may then prepare to receive data. For example, the UE2 1724 and UE3 1726 may start an application for receiving and/or using the data. HA1 1730 may start replicating the data once HA2 1732 and/or HA3 1728 have accepted the request.

Alternatively, as illustrated in FIG. 17, replication may be triggered by a target UE, such as UE3 1726 for example. According to this example, HA3 1728 may perform the authorization and/or may forward the request to the source HA1 1730 at 1708. HA1 may receive the request, perform an authorization, and/or send the request to HA2 1732, at 1712, for authorization and/or preparation. HA2 1732 may send the request to UE2 1724 at 1716 to prepare to receive data. For example, the UE2 1724 may start an application for receiving and/or using the data.

According to an embodiment, an HA may interact with a REPLICATOR, which may handle data replication to peer devices. For example, the HA may interact with a REPLICATOR, which handles data replication to peer devices. In one example embodiment, a UE may request, via an HA associated with the UE, to replicate a flow towards another user equipment. In an alternative example embodiment, replication may be triggered by a target UE.

As illustrated in FIG. 18, for example, in an embodiment, a UE1 1824 may make a request at 1802, via the HA1 1826, to replicate a flow towards UE2 1834 and/or UE3 1836. Authorization may be obtained using pre-configured information. HA1 1826 may send a replication requests at 1814 to an HA2 1830 and/or at 1810 to an HA3 1832 associated with a UE2 1834 and a UE3 1836, respectively. HA2 1830 may handle the authorization and/or send the request to the UE2 1834 at1816. HA3 1832 may handle the authorization and/or send the request to the UE3 1836 at 1820. UE2 1834 and UE3 1836 may prepare to receive data. For example, the UE2 1834 and UE3 1836 may start an application for receiving and/or using the data. The data replication may start at this point. For example, HA1 1826 may send the request to the REPLICATOR 1828 at 1806.

Alternatively, as illustrated in FIG. 18, replication may be triggered at 1822 by a target UE, such as UE3 1836 for example. HA3 1832 may perform the authorization and/or may forward the request at 1808 to the source HA1 1826. HA1 1826 may receive the request, perform an authorization, and/or may send the request to HA2 1830 at 1812 for authorization and/or preparation. HA2 1830 may send the request to UE2 1834 at 1818 to prepare UE2 1834 to receive data. For example, the UE2 1834 may start an application for receiving and/or using the data. HA1 1826 may send the request to the REPLICATOR 1828 at 1804 once all of the target UEs are ready.

According to an embodiment, an HA may interact with a Session Controller (SC), which may handle the session control. Replication may be handled by the REPLICATOR node or by the HA. The HA may interact with an SC in handling control information in an MIP system. The SC may handle the session control, and replication may be handled by the REPLICATOR node or by a HA. In one example embodiment, a UE may request, via an HA associated with the UE, to replicate a flow towards another user equipment. In an alternative example embodiment, replication may be triggered by a target UE.

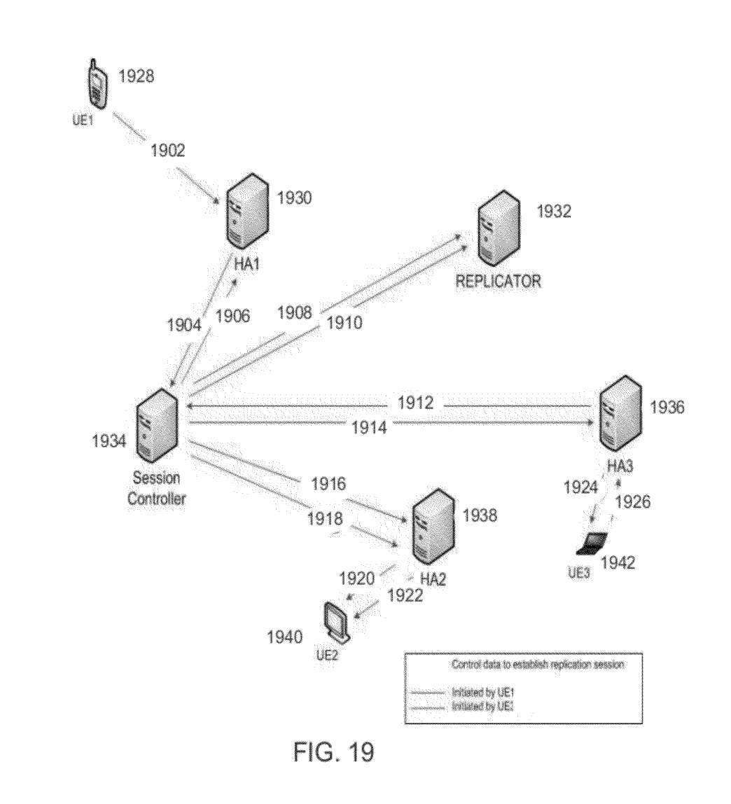

As illustrated in FIG. 19, for example, in the first embodiment, UE1 1928 may make a request at 1902, via HA1 1930, to replicate a flow towards UE2 1940 and/or UE3 1942. Authorization may be obtained using pre-configured information. HA11930 may send replication requests at 1904 to the SC 1934. The SC 1934 may send the request at 1916 to HA2 1938 and/or at 1914 to HA3 1936 to handle the authorization. HA2 1938 and/or HA3 1936 may send the request to UE2 1940 at 1922 and/or to UE3 1942 at 1924, respectively, so that they may each prepare to receive data. For example, the UE2 1940 and UE3 1942 may start an application for receiving and/or using the data. The SC 1934 may send the request to the REPLICATOR 1932 at 1910. The data replication may start when the SC 1934 sends the request to the REPLICATOR 1932.

Alternatively, as illustrated in FIG. 19, replication may be triggered at 1926 by a target UE, such as UE3 1942 for example. HA3 1942 may perform the authorization and/or forward the request to the SC 1934 at 1912. The SC 1934 may receive the request and send the request to the source HA1 1930 at 1906. HA1 1930 may perform the authorization. The SC 1934 may then send the request to HA2 1938 at 1918 for authorization and/or preparation. HA2 1938 may also send the request to UE2 1940 at 1920 to prepare UE2 1940 for data reception. For example, the UE2 1940 may start an application for receiving and/or using the data. The SC 1934 may send the request to the REPLICATOR 1932 at 1908 after at least one of the target UEs are ready.

According to an embodiment, an HA may interact with an Authorization Entity (AE), which may handle the authorization of the replication session. Replication may be handled by the REPLICATOR node or by the HA. Session Control may be handled by the SC node or by the HA. The HA may interact with an Authorization Entity (AE) in handling control information in a MIP architecture. The AE may handle the authorization of the replication session. Replication may be handled by the REPLICATOR node or by a HA. Session Control may be handled by the SC node or by a HA. At least two embodiments may be implemented. In one example embodiment, a UE may request, via an HA associated with the UE, to replicate a flow towards another user equipment. In an alternative example embodiment, replication may be triggered by a target UE.

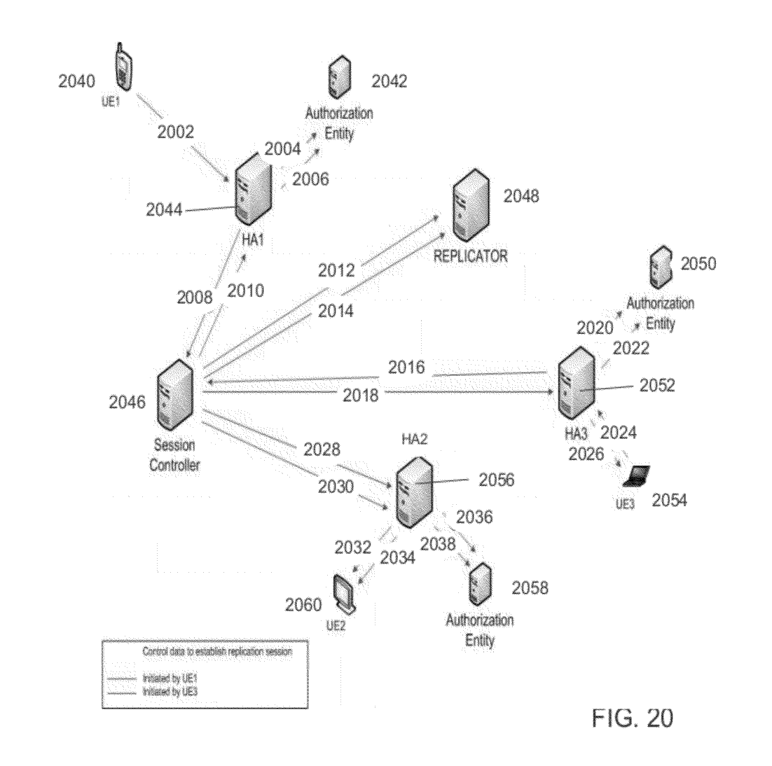

As illustrated in FIG. 20, for example, in the first embodiment, UE1 2040 may make an request at 2002, via HA1 2044, to replicate a flow towards UE2 2060 and/or UE3 2054. HA1 2044 may obtain authorization from an AE 2042 at 2004. HA1 2044 may send a replication request at 2008 to the SC 2046. The SC 2046 may send the request to HA2 2056 at 2028 and/or to HA3 2052 at 2018. HA2 2056 may obtain authorization at 2038 from AE 2058 that is associated with HA2 2056. HA3 2052 may obtain authorization at 2022 from AE 2050 that is associated with HA3 2052. HA2 2056 and HA3 2056 may also send the request to UE2 2060 at 2034 and UE3 2054 at 2026, respectively. UE2 2060 and UE3 2054 may then prepare to receive data. For example, the UE2 2060 and UE3 2054 may start an application for receiving and/or using the data. The SC 2046 may then send the request to the REPLICATOR 2048 at 2014. The data replication may start once the SC 2046 sends the request to the REPLICATOR 2048.

Alternatively, as illustrated in FIG. 20, replication may be triggered at 2024 by a target UE, such as UE3 2054 for example. HA3 2052 may obtain the authorization from AE 2050 associated with the HA3 2052 at 2020 and forward the request to the SC 2046 at 2016. The SC 2046 may send the request to the source HA1 2044 at 2010, which may obtain the authorization from the AE 2042 at 2006. The SC 2046 may then send the request to HA2 2056 at 2030 for authorization and/or preparation. HA2 2056 may obtain the authorization from the AE 2058 associated with the HA2 2056 and then may send the request to UE2 2060 at 2032. UE2 2060 may then prepare for data reception. For example, the UE2 2060 may start an application for receiving and/or using the data. The SC 2046 may send the request to the REPLICATOR 2048 at 2012 after at least one of the target UEs are ready.

According to an embodiment, an HA may interact with the REPLICATOR, which may handle data replication and session control. The HA may interact with a REPLICATOR that may perform the session control when handling control information in an MIP architecture. The REPLICATOR may handle data replication and/or session control. In one example embodiment, a UE may request, via an HA associated with the UE, to replicate a flow towards another user equipment. In an alternative example embodiment, replication may be triggered by a target UE.

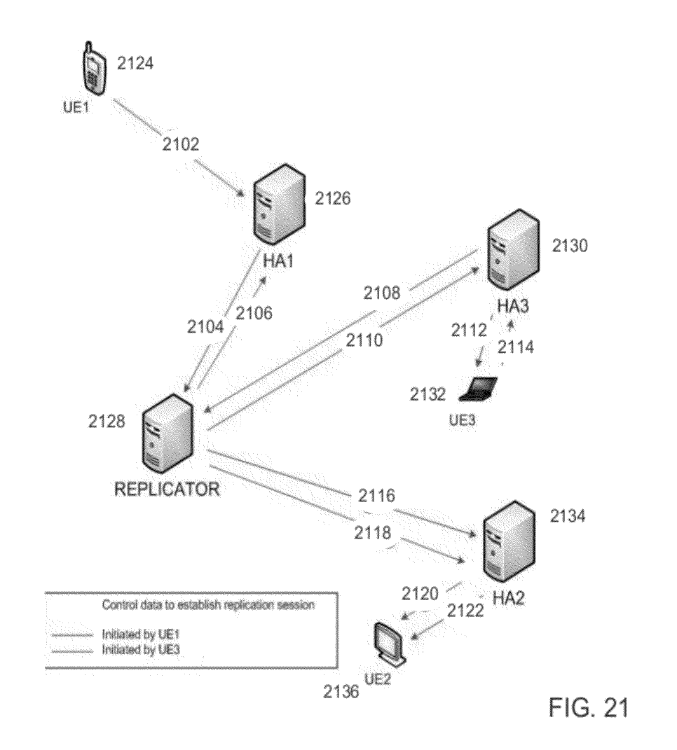

As illustrated in FIG. 21, for example, a UE1 2124 may make a request at 2102, via HA1 2126, to replicate a flow towards UE2 2136 and/or UE3 2132. Authorization may be obtained using pre-configured information. HA1 2126 may send a replication request to the REPLICATOR 2128 at 2104. The REPLICATOR 2128 may send the request at 2116 to HA2 2134 and/or HA3 2130 at 2110 to handle the authorization. HA2 2134 may send the request to UE2 2136 at 2122 and/or HA3 2130 may send the request to the UE3 2132 at 2112. UE2 2136 and UE3 2132 may then prepare to receive data. For example, the UE2 2136 and UE3 2132 may start an application for receiving and/or using the data.

Alternatively, as illustrated in FIG. 21, replication may be triggered at 2114 by a target UE, such as UE3 2134 for example. HA3 2130 may perform the authorization and may forward the request to the REPLICATOR 2128. The REPLICATOR 2128 may receive the request and/or may send it to the source HA1 2126 at 2106. The source HA1 2126 may perform the authorization and/or the REPLICATOR 2128 may send the request to HA2 2134 at 2118 for authorization and/or preparation. HA2 2134 may send the request to UE2 2136 at 2120. UE2 2136 may then prepare for data reception. For example, the UE2 2136 may start an application for receiving an/or using the data.

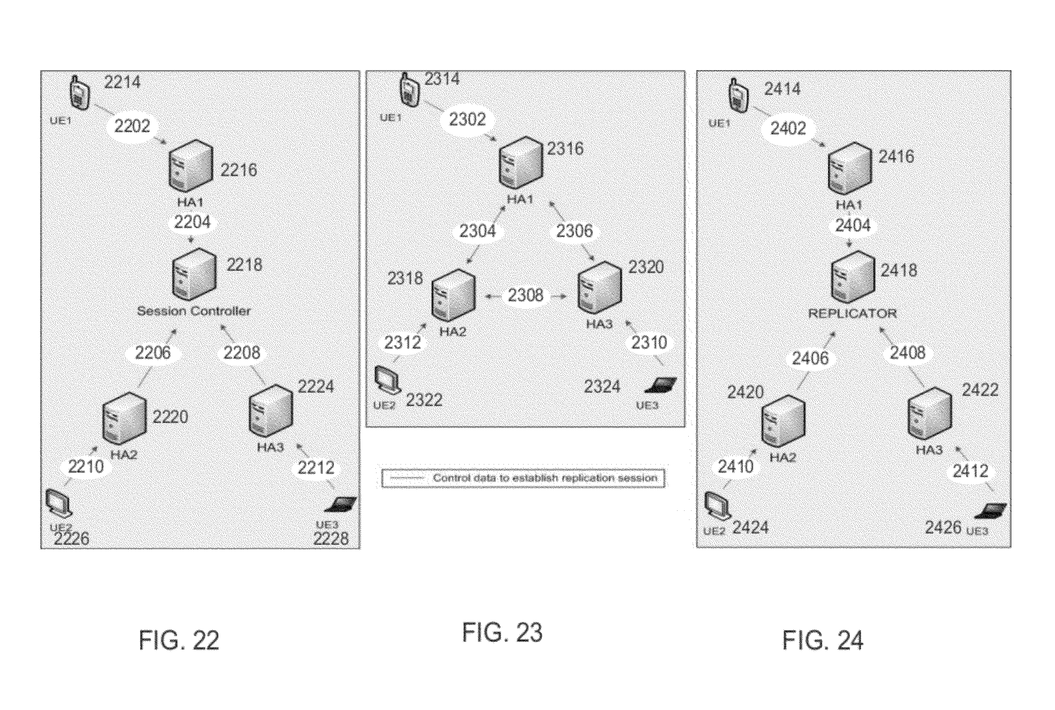

According to an embodiment, devices may register with the entity handling session control to receive duplicated data. For example, UE devices may register with an entity that handles session control to receive duplicated control information. For example, UEs that want to participate in a replication session may register, via an associated HA. As illustrated in FIG. 22, UE1 2214, UE2 2226, and UE3 may register with SC 2218. For example, UE1 2214 may send a registration message at 2202 to HA1 2216, UE2 2226 may send a registration message at 2210 to HA2 2220, and/or UE3 2228 may send a registration message at 2212 to HA3 2224. HA1 2216, HA2 2220, and/ or HA3 2224 may send a registration message to SC 2218 at 2204, 2206, and/or 2208 respectively. Thus, each HA may register with SC 2218 on behalf of an associated UE.

As illustrated in FIG. 23, when the HAs may be handling the session control, the HAs may share the registrations among themselves. In FIG. 23, UE1 2314 may send a registration message at 2302 to HA1 2316, UE2 2322 may send a registration message at 2312 to HA2 2318, and/or UE3 2324 may send a registration message at 2310 to HA3 2320. HA1 2316, HA2 2318, and/or HA3 2320 may share registration among themselves by sending registration messages at 2304, 2306, and/or 2308.

As illustrated in FIG. 24, when the REPLICATOR may be handling the session control, each HA may register an associated UE device with the REPLICATOR. In FIG. 24, UE1 2414 may send a registration message at 2402 to HA1 2416, UE2 2424 may send a registration message at 2410 to HA2 2420, and/or UE3 2426 may send a registration message at 2412 to HA3 2422. HA1 2416, HA2 2420, and/or HA3 2422 may send a registration message to REPLICATOR 2418 at 2404, 2406, and/or 2408 respectively. Thus, each HA may register with REPLICATOR 2418 on behalf of an associated UE.

A number of replication/transfer scenarios are contemplated, as described herein. For example, replicated data may be received from a Correspondent Node (CN) and/or replicated to multiple devices. In another example, the replicated data may have originated from participating devices and/or replicated to other participating devices. In one embodiment, the HA may handle data replication. In another embodiment, the REPLICATOR and/or the SC may handle data replication. The entity handling the data replication may also responsible for handling the sessions (e.g. TCP/UDP) between itself and the destinations. Data ACKs from the destinations may be sent to the entity handling the replication.

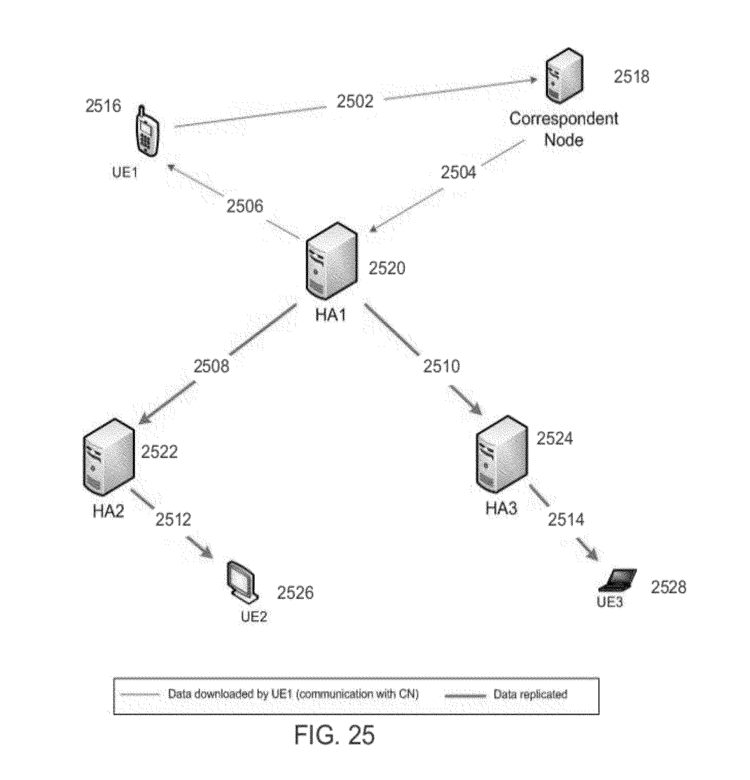

FIG. 25 is an example of data being received from a Correspondent Node (CN) 2518 and/or replicated to multiple devices. As illustrated in FIG. 25, data may be downloaded from a CN 2518 and may be shared with peer UEs, while an HA may handle data replication. In FIG. 25, UE1 2516 may start a download with the CN 2518 at 2502. The CN 2518 may send data to UE1 2516. The data may be sent via HA1 2520 associated with UE1 2516 by sending the data from CN 2518 to HA1 2520 at 2504 and then forwarding data from HA1 2520 to UE1 2516 at 2506. For example, the CN 2518 may use a Home Address (HoA) associated with the UE1 2516. The HA1 2520 may forward the data using the Care-of-Address (CoA). HA1 2520 may send a copy of the data to UE2 2526 and/or UE3 2528. HA1 2520 may send the data via HA2 2522 and/or HA3 2524 at 2508 and/or 2510 respectively. The data may be sent using MIP flow filtering capability or the like. HA2 2522 and/or HA3 2524 may forward the data to UE2 2526 and/or UE3 respectively. For example, HA2 2522 may send the data at 2512 and/or HA3 2524 may send the data at 2514. HA2 and HA3 may use regular MIP forwarding for example.

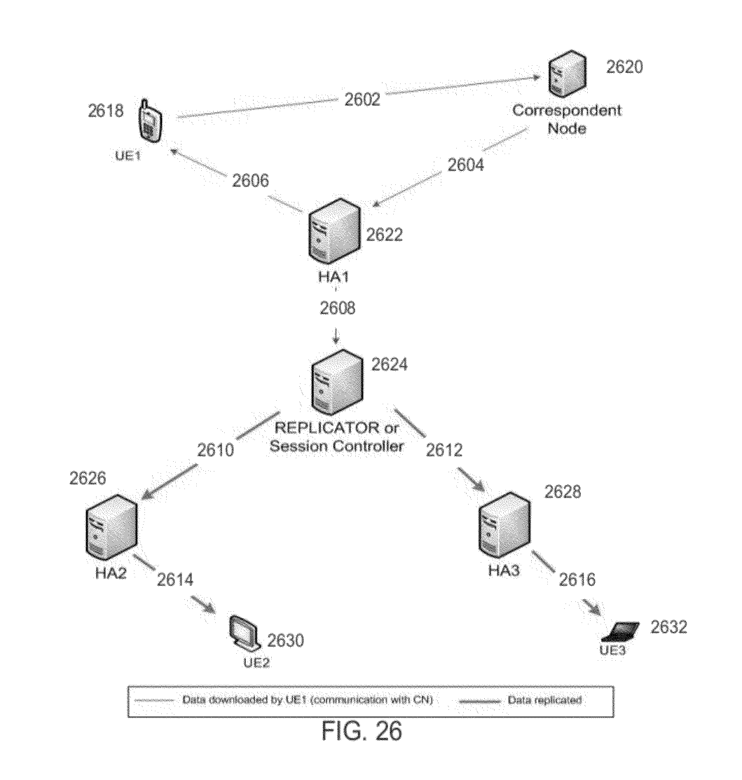

FIG. 26 is an example of data that is originated from participating devices being replicated to other participating devices. As illustrated in FIG. 26, data may be downloaded from the CN 2620 and shared with peer UEs, while a REPLICATOR and/or a SC 2624 handles data replication. In FIG. 26, UE1 2618 may start a download with the CN at 2602. The CN 2620 may send data to UE1 2618, via the HA1 2622 associated with UE1 2618. For example the CN 2620 may send data to HA1 2622at 2604 and HA1 2622 may forward the data to UE1 2618. For example, the CN 2620 may use a Home Address (HoA) associated with the UE1 2618 when sending data at 2604. The HA1 2622 may forward the data using the Care-of-Address (CoA). The HA1 2622 may send a copy of the data to the REPLICATOR and/or SC 2624 at 2608. For example, the HA1 2622 may send a copy of the data using MIP flow filtering capability or the like. The REPLICATOR and/or SC 2624 may replicate the data and send it to the registered UEs, such as UE2 2630 and/or UE3 2632 for example. The replicated data may be sent via HA2 2626 at 2610 and/or HA3 2628 at 2612. HA2 2626 and/or HA3 2628 may then forward the data to UE2 2630 and UE3 2632 respectively. For example, HA2 2626 and HA3 2628 may forward the data at 2614 and 2616 respectively. HA2 2626 and HA3 2628 may use regular MIP forwarding for example.

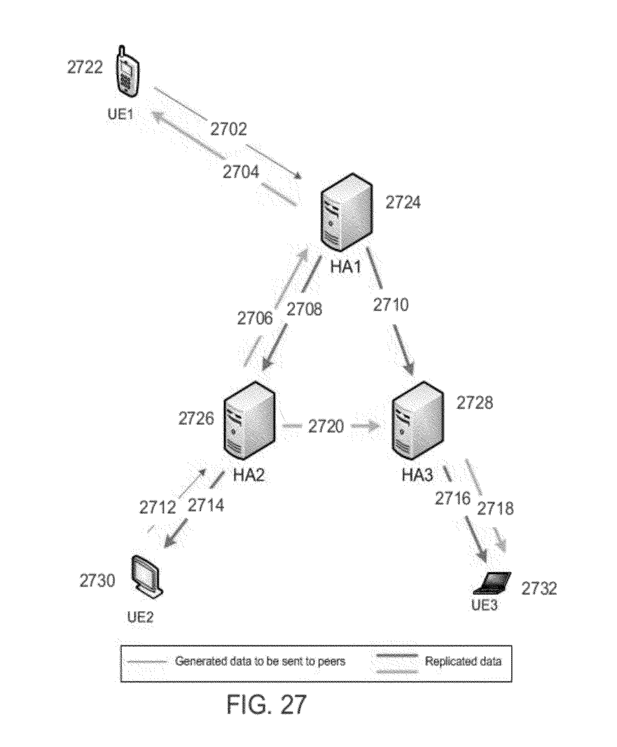

As illustrated in FIG. 27, data may be generated and shared with peer UEs, while a HA may handle the data replication. In FIG. 27, a UE, such as UE1 2722 for example, may generate data that may be shared with the peers of the UE, such as UE2 2730 and/or UE3 2732 for example. The data generated by the UE may be sent to an associated HA, such as HA1 2724, at 2702. The HA may send copies of the data to the registered peers, such as UE2 2730 and/or UE3 2732. The data may be sent at 2708 and/or 2710 via an associated HA, such as HA2 2726 and/or HA3 2728 for example. HA2 2726 and/or HA3 2728 may forward the data at 2714 and/or 2716 to UE2 2730 and/or UE3 2732 at their current location. The data may be forwarded by using regular MIP forwarding, using the CoA associated with the UE2 2730 and/or UE3 2732 for example. Additionally, UE2 2730 may generate data that may be shared with the peers of UE2 2730, such as UE1 2722 and/or UE3 2732 for example. The data generated by UE2 2730 may be sent at 2712 to an associated HA, such as HA2 2726 for example. The HA may send a copy of the data to the registered peers, such as UE1 2722 and/or UE3 2732. The replicated data may be sent at 2706 to the HA1 2724 and/or at 2720 to HA3 2728 associated with UE1 2722 and UE3 2732 respectively. HA1 2724 and/or HA3 2728 may forward the data to the UE1 2722 and/or UE3 2732 at their current location. For example, HA1 2724 may forward data at 2704 and HA3 2728 may forward data at 2718. The data may be forwarded by using regular MIP forwarding, using the CoA associated with the UE1 2722 and UE3 2732 for example.

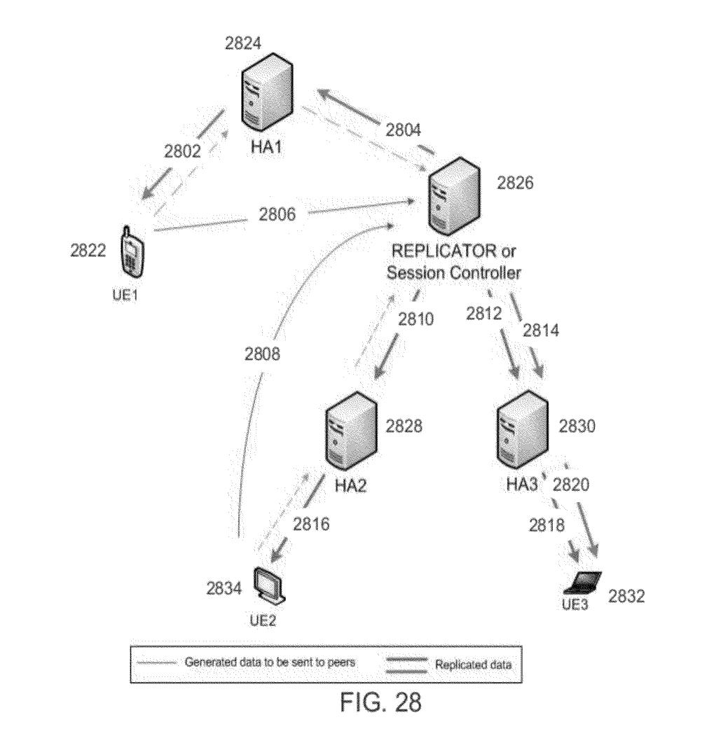

As illustrated in FIG. 28, data may be generated and shared with peers, while a REPLICATOR and/or SC may handle the data replication. In FIG. 28, a UE, such as UE1 2822, may generate data that may be shared with the peers of the UE, such as UE2 2834 and/or UE3 2832 for example. The data generated by the UE may be sent directly to a REPLICATOR and or Session Controller 2826 at 2806 or it may optionally transit through the associated HA, such as HA1 2824 for example. The REPLICATOR may send copies of the data to the registered peers, such as UE2 2834 and/or UE3 2832. The data may be sent to UE2 2834 and/or UE3 2832 via the associated HA2 2828 at 2810 and/or HA3 2830 at 2812. HA2 2828 and HA3 2830 may forward the data at 2816 and 2818 to the UE2 2834 and UE3 2832 at their current location. The data may be forwarded by using regular MIP forwarding, using the CoA associated with the UE2 2834 and UE3 2832 for example. Additionally, a peer UE, such as UE2 2834, may generate data that may be shared with the peers of the UE, such as UE1 2822 and/or UE3 2832 for example. The data generated by UE2 2834 may be sent directly to the REPLICATOR and/or a SC 2826 at 2808 or it may optionally transit through an associated HA, such as HA2 2828 for example. The REPLICATOR may send a copy of the data to the registered peers, such as UE1 2822 and/or UE3 2832. The data may be sent via the associated HA1 2824 at 2804 and/or HA3 2830 at 2814. HA1 2824 and/or HA3 2830 may forward the data to the UE1 2822 and/or UE3 2832, respectively, at their current location. For example, HA1 2824 and/or HA3 2830 may forward the data at 2802 and/or 2820. The data may be forwarded using regular MIP forwarding, using the CoA associated with the UE1 2822 and/or UE3 2832 for example.

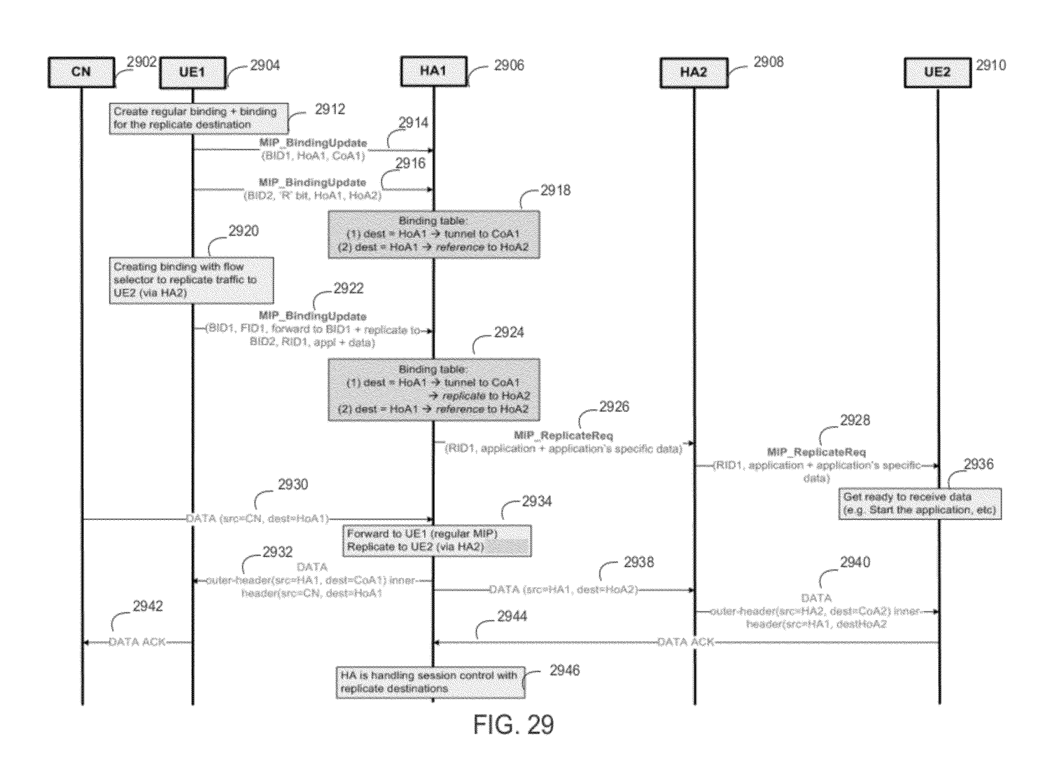

FIG. 29 shows an example of a sequence flow diagram where an HA may be handling data replication and/or session control. FIG.29 also illustrates an example of the various MIP messages that may be implemented in transmitting and replicating data and/or control information in an MIP system.

As illustrated in FIG. 29, UE1 2904 may create a regular binding and binding for the replicate destination at 2912. At 2914 UE1 2904 may send a binding update 2904 to HA1 2906. The binding update message may include parameters such as the binding identifier associated with the UE, the HoA associated with the UE, and/or the CoA associated with the UE. At 2916, UE1 2904 may send a binding update associated with UE2 2910. For example, the binding update may include the binding identifier associated with UE2 2910, an ‘R’ bit, a HoA1, and an HoA2. HA1 2906 generates a binding table at 2918. UE1 2904 may create a binding with a flow selector to replicate traffic to UE2 2910 at 2920. At 2922, a binding update message may be sent from UE1 2904. At 2924, HA1 2906 may generate a binding table. HA1 2906 may send a replicate request message to HA2 2908 at 2926. HA2 2908 may forward the replication request message to UE2 2910 at 2928. At 2936, UE2 2910 may get ready to receive data (e.g., start an application for receiving and/or using the data).

CN 2902 may send data to HA1 2906 at 2930. HA1 2906 may decide to forward the data to UE1 2904 and/or replicate the data to UE2 2910, such as via HA2 2908 for example. HA1 2906 may send the data to UE1 2904 at 2932. The UE1 2904 may send a data ack to CN 2902 at 2942. The data may be replicated to HA2 2908 at 2938. At 2940, the data may be forwarded to UE2 2910. The UE2 2910 may send a data ack to HA1 2906 at 2944. HA1 2906 may handle session control with replicated destinations at 2946.

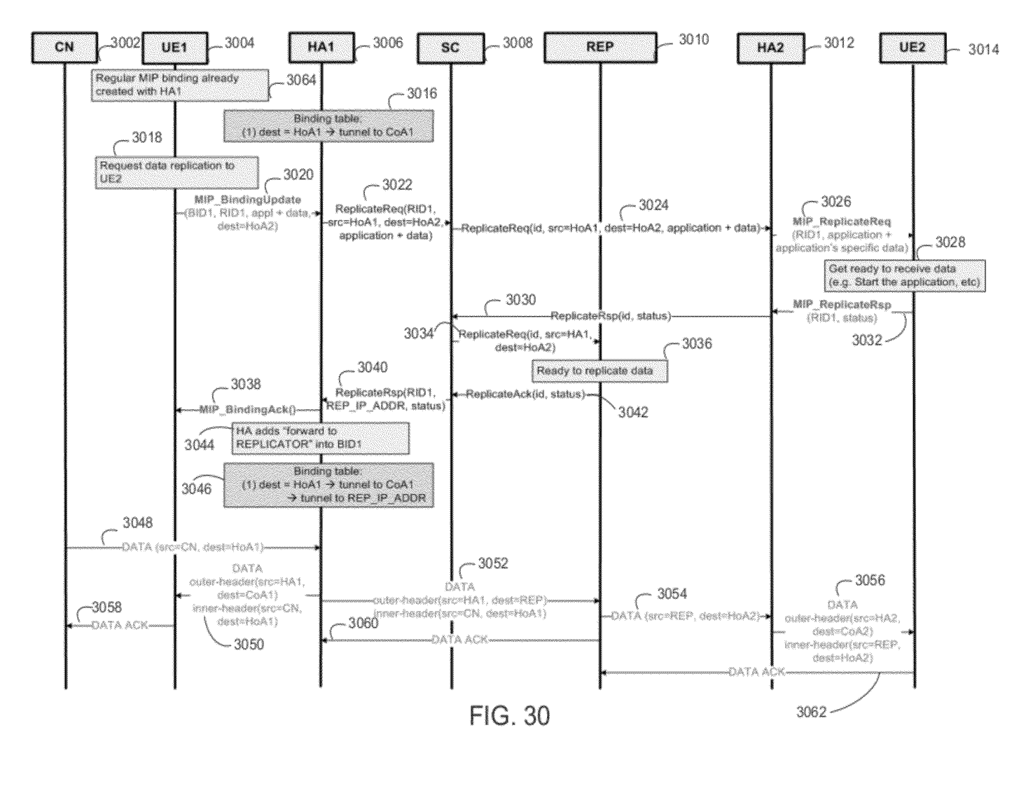

FIG. 30 shows an example of a sequence flow diagram where a REPLICATOR and an SC may be handling data replication and/or session control. FIG. 30 also illustrates an example of the various MIP messages that may be implemented in transmitting and replicating data and/or control information in an MIP system.

As illustrated in FIG. 30, at 3064, binding may be created with HA1 3006. At 3016, HA1 may create a binding table. The UE1 3004 may request data replication to UE2 3018 at 3018. At 3020, UE1 3004 may send a binding update message (e.g., MIP binding update message) to HA1 3006. The HA1 3006 may send a replication request message to SC 3008 at 3022. The SC 3008 may forward the replication request message to HA2 3012 at 3024. At 3026, the HA2 3012 may send a replication request message (e.g., MIP replication request message) to UE2 3014. At 3028, UE2 3014 may get ready to receive data (e.g., start an application to receive and/or use the data). The UE2 3014 may send a replication response message (e.g., MIP replication response message) at 3032. The HA2 3012 may send a replication response message at 3030 to SC 3008. The SC 3008 may send a replication request message at 3034 to REPLICATOR 3010.

REPLICATOR 3010 may replicate the data at 3036. A replication ack message may be sent from REPLICATOR 3010 to SC 3008 at 3042. At 3040, SC 3008 may send a replication response message to HA1 3006 at 3040. At 3038, HA1 3006 may send a binding ack message (e.g., an MIP binding ack message) to UE1 3004. HA1 3006 may add a “forward to REPLICATOR” message into BID1 at 3044 and generate configure the binding table at 3046.

CN 3002 may send data to HA1 3006 at 3048, which may be forwarded on to UE1 3004 at 3050. After UE1 3004 receives the data it may send a data ack at 3050 to CN 3002. HA1 3006 may also send data to the REPLICATOR 3010 at 3052, which may forward the data to HA2 3012 at 3054. After REPLICATOR 3010 receives the data, it may send a data ack to HA1 3006 at 3060. At 3056, HA2 3012 may send the data to UE2 3014. After UE2 3014 receives the data, it may send a data ack to REPLICATOR 3010 at 3062.

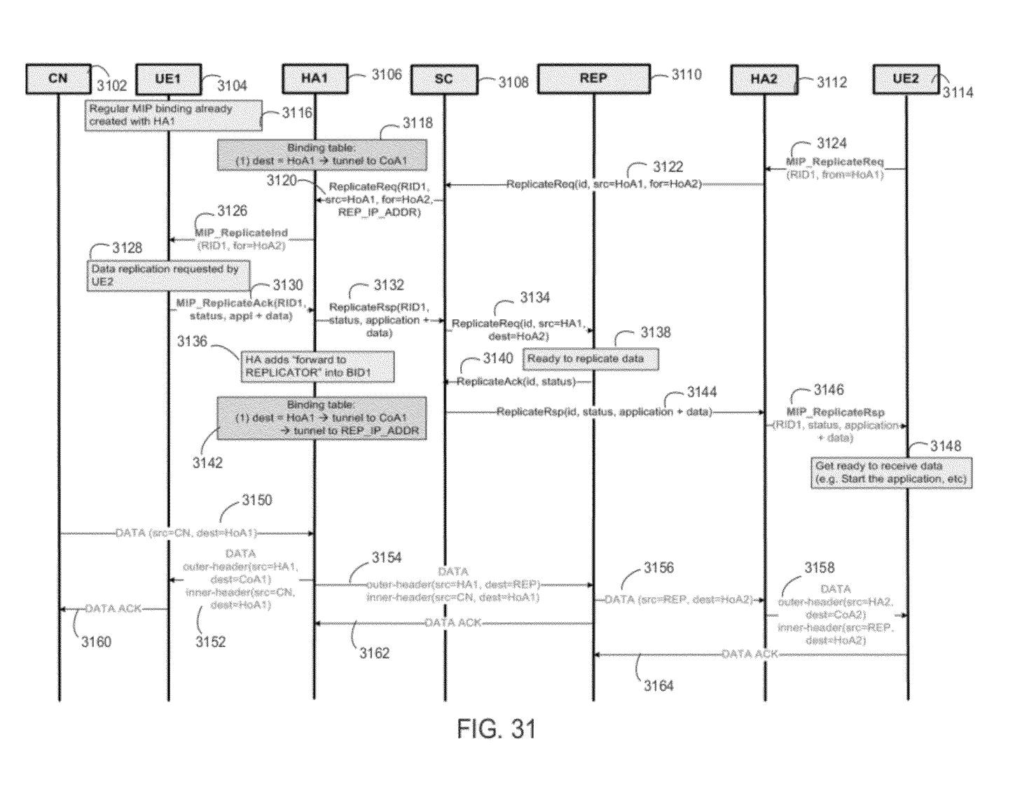

FIG. 31 shows an example of a sequence flow diagram where a replication request originates from a target UE and a REPLICATOR and a SC may be handling data replication and/or session control. FIG. 31 also illustrates an example of the various MIP messages that may be implemented in transmitting and replicating data and/or control information in an MIP system.

As illustrated in FIG. 31, 3104 may have an MIP binding created with HA1 3106 at 3116. HA1 3106 may have a binding table created at 3118. UE2 3114 may send a replication request message (e.g., an MIP replication request message) to HA2 3112 at 3124. At 3122, HA2 3112 may forward the replication request message to SC 3108. SC 3108 may send the replication request message to HA1 3106 at 3120. At 3126, HA1 3106 may send a replication indicator message (e.g., an MIP replication indicator message) to UE1 3104.

UE1 3104 may determine the data requested by UE2 3114 at 3128. At 3130, UE1 3104 may send a replication ack message (e.g., an MIP replication ack message) to HA1 3106. A replication response message may be sent from HA1 3106 to SC 3108 at 3132. At 3136, HA1 3106 may add a “forward to REPLICATOR” message into the BID1 and update the binding table at 3142 (e.g., add a tunnel to the REPLICATOR IP address).

After receiving the replication ack message from UE1 3104, SC 3108 may send a replication request message to REPLICATOR 3110 at 3134. At 3138, REPLICATOR 3110 may prepare to replicate data. A replication ack message may be sent from the REPLICATOR 3110 to SC 3108 at 3140. After receiving the replication ack message at 3140, SC 3108 may send a replication response message to HA2 3112 at 3144. HA2 3112 may send a replication response message (e.g., MIP replication response message) to UE2 3114 at 3146. At 3148, UE2 3114 may prepare for receiving data (e.g., start an application for receiving and/or using the data).

At 3150, CN 3102 may send data to HA1 3106. HA1 3106 may forward the data to UE1 3104 at 3152 and UE1 3104 may send a data ack to CN 3102 at 3160. HA1 3106 may send data to REPLICATOR 3110 at 3154. For example the data may be sent to REPLICATOR 3110 for replication to UE2 3114. After REPLICATOR 3110 has received the data, it may send a data ack to HA1 3106 at 3162. At 3156, the data may be sent from REPLICATOR 3110 to HA2 3112. HA2 3112 may forward the data to UE2 3114 at 3158. After receiving the data at 3158, UE2 3114 may send a data ack to REPLICATOR 3110 at 3164.

As shown in FIGS. 29, 30, and 31, an MIP protocol may implement various MIP messages. The MIP messages may include messages such as MIP_BindingUpdate( ) MIP_ReplicationReq(identifier, application, application's specific data), MIP_ReplicationRsp(identifier, status, application, application's specific data), MIP_ReplicationInd(identifier, from_IP_address), MIP_ReplicationAck(identifier, status, application, application's specific data), or the like.

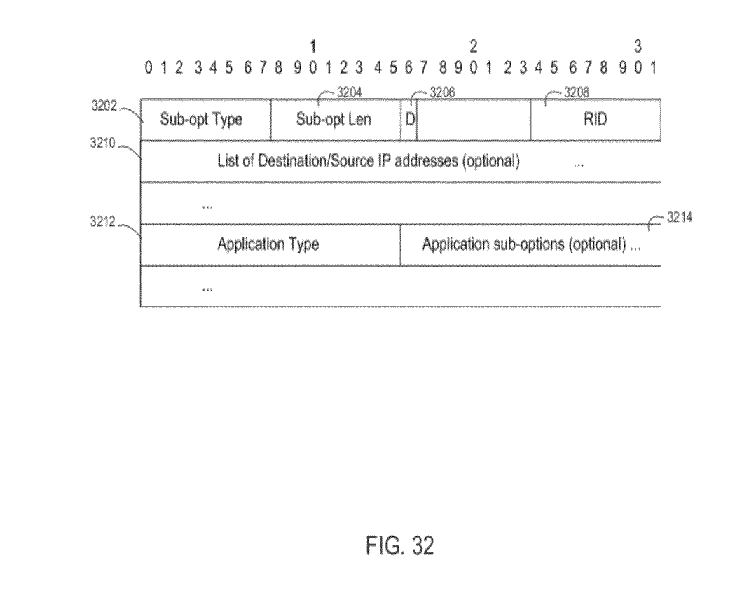

MIP_BindingUpdate( ) or the like may support a replication option, as illustrated in FIG. 32 for example. MIP_BindingUpdate( ) or the like may also include a reference bit, such as an ‘R’ bit or the like, which may be used as a reference for replication for example. The reference bit, or ‘R’ bit, may not used in the forwarding table.

MIP_ReplicationReq(identifier, application, application's specific data) or the like may be used to carry application information to prepare the targets for reception of the replicated data. MIP_ReplicationReq(identifier, application, application's specific data) or the like may also be used to request replication from another UE.

MIP_ReplicationRsp(identifier, status, application, application's specific data) or the like may be used to respond to a replication request. Additionally, MIP_ReplicationRsp(identifier, status, application, application's specific data) or the like may be used to carry application information to prepare the targets for the reception of replicated data, such as when a request may be sent from a target UE, as illustrated in FIG. 31 for example.

MIP_ReplicationInd(identifier, from_IP_address) or the like may be used by a target UE to request replication from another UE.

MIP_ReplicationAck(identifier, status, application, application's specific data) or the like may be used to respond to a replication indication. Additionally, MIP_ReplicationAck(identifier, status, application, application's specific data) or the like may be used to carry application information to prepare the targets for the reception of the replicated data.

FIG. 32 illustrates a replication mobility option that may be implemented in an MIP protocol. The replication mobility option may include a type that may be used for this option, such as a Sub-opt Type 3202 or the like. A ‘D’ bit 3206 or the like may be set when the IP address or addresses specified in the option represent the IP addresses of the destinations, such as the target UEs for example, as illustrated in FIG. 29 at the binding update message at 2922 (e.g., MIP_BindingUpdate message). When the ‘D’ bit or the like is not set, the IP addresses may represent the source IP addresses from which data may be replicated, as used on the replication request message (e.g., MIP_ReplicateReq message) illustrated in FIG. 31 for example.

As illustrated in FIG. 32, the MIP protocol may also include a Replicate Identification (RID) Mobility Option 3208, a list of destination/source IP addresses 3210, an Application Type 3212, and/or Application sub-options 3214. The list of destination/source IP addresses 3210 may include the IP addresses where replicated data may be sent and/or from which the replicated data has been sent. The list of destination/source IP addresses 3210 may be optional when the replication option may be used to carry an application's data. Application Type 3212 may define which application may be prepared to receive data. Application Type 3212 may also be optional when the replication option may be used by a target UE to request replication. Application sub-options 3214 may be specific to the application, such as rate adaptation and packet size for example. Application sub-options 3214 may be optional when the replication option may be used by a target UE to request replication or when there may be no specific information related to the specified application for example.

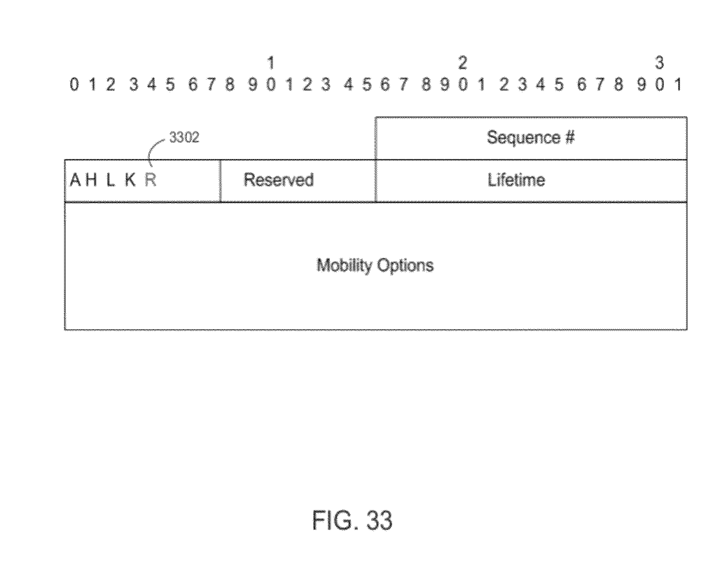

FIG. 33 illustrates an ‘R’ bit or ‘Reference’ bit 3302 in the Binding Update message, such as the MIP_BindingUpdate( ) message or the like as described herein. The ‘Reference’ bit 3302 may be set by the sending mobile node to configure a binding entry that may be used as a reference. For example, a binding may be specified into a flow identification binding reference sub-option, for replication or the like. The binding entry may be used as a reference and may not be used in the forwarding table as a regular binding. The reference binding entry may be able to use the currently flow binding format. For example the reference binding entry may be able to point to the destinations using a binding entries identifier.

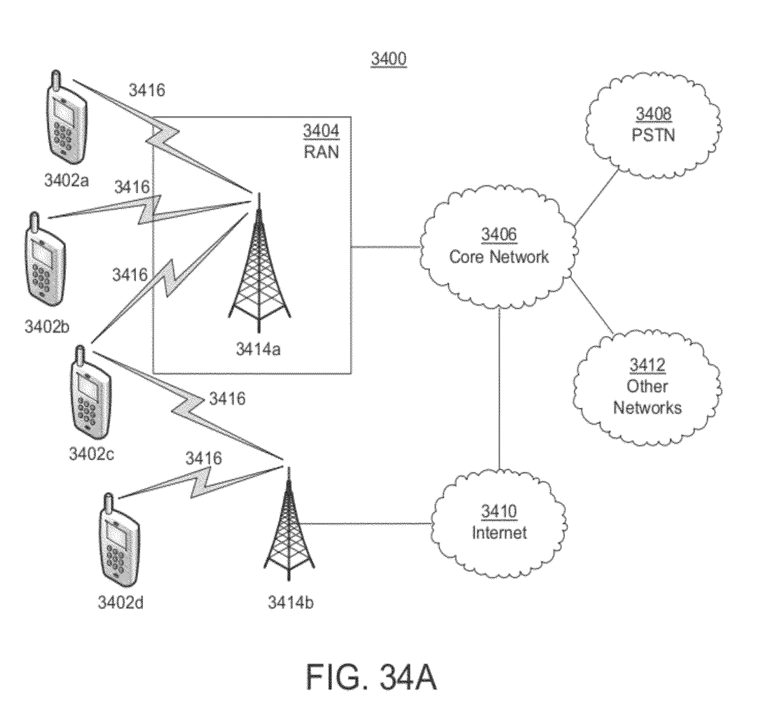

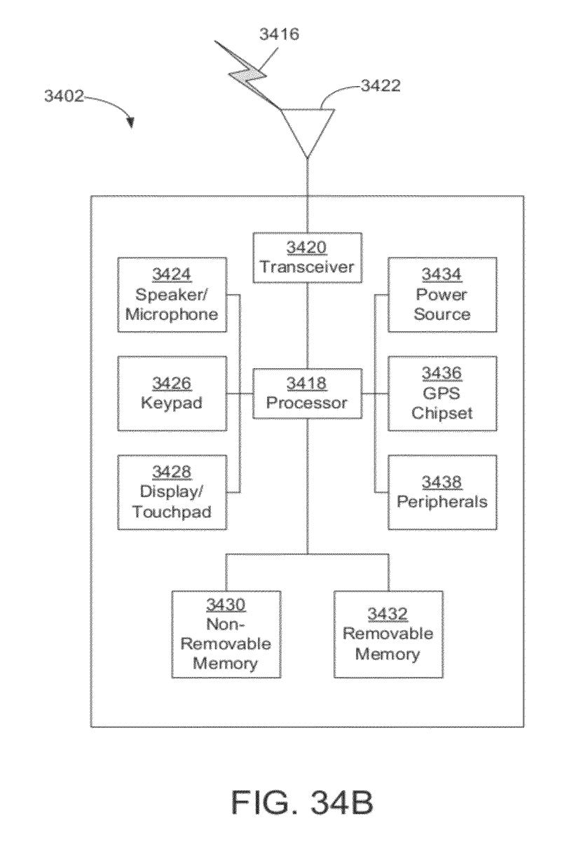

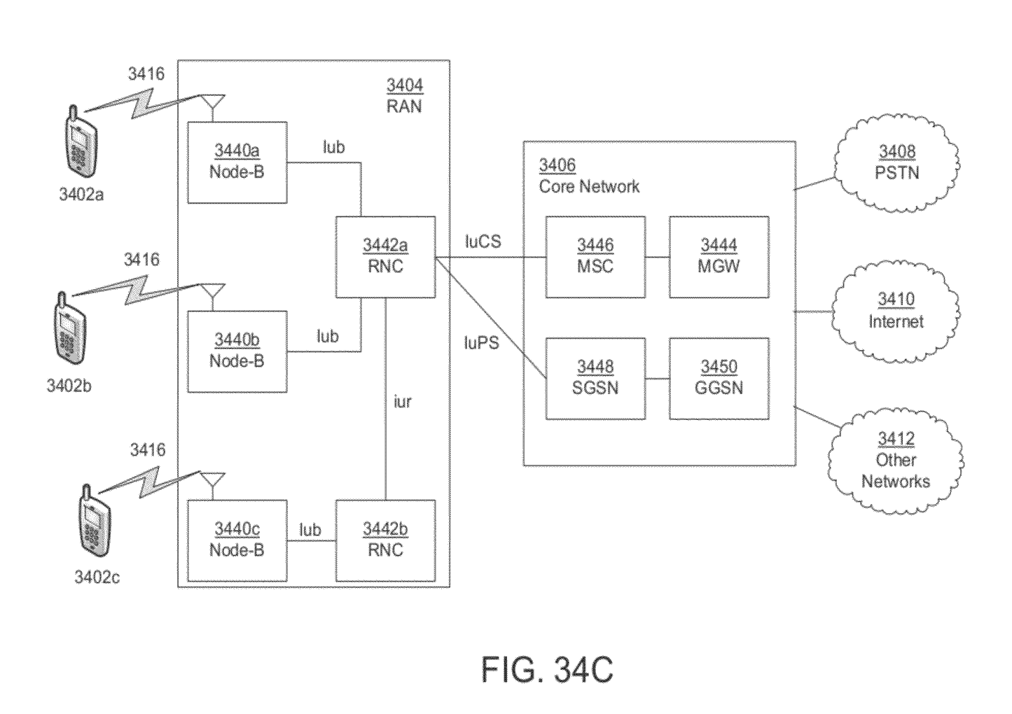

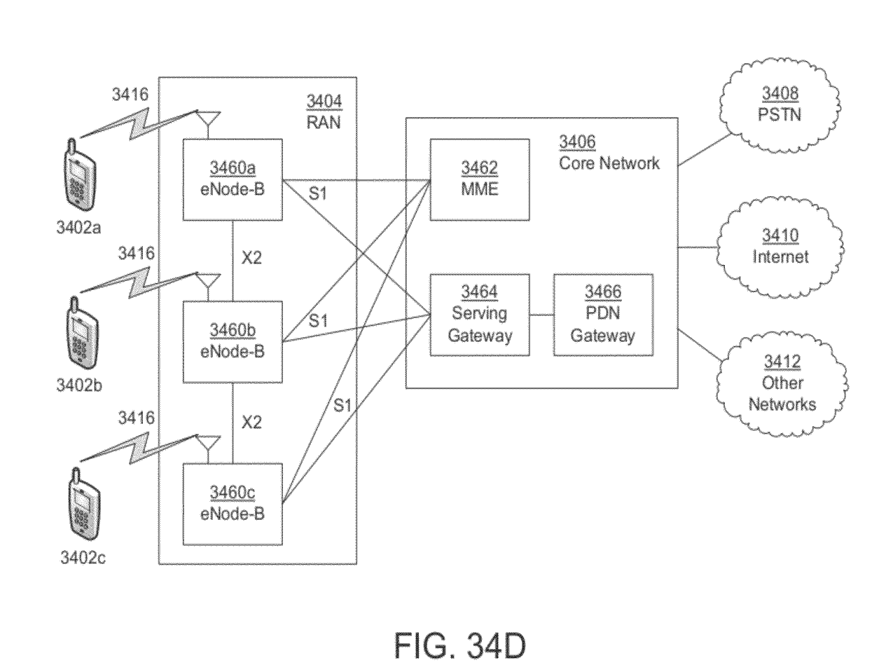

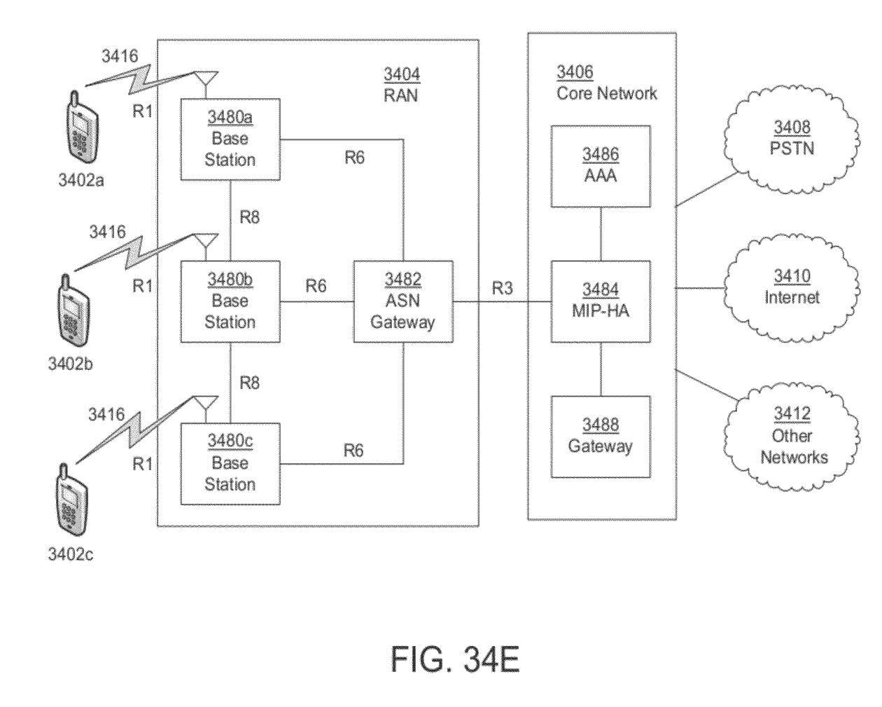

FIGS. 34A-34E illustrate exemplary communications systems in which one or more disclosed embodiments may be implemented.

FIG. 34A is a diagram of an example communications system 3400 in which one or more disclosed embodiments may be implemented. The communications system 3400 may be a multiple access system that provides content, such as voice, data, video, messaging, broadcast, etc., to multiple wireless users. The communications system 3400 may enable multiple wireless users to access such content through the sharing of system resources, including wireless bandwidth. For example, the communications systems 3400 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 34A, the communications system 3400 may include wireless transmit/receive units (WTRUs) 3402a, 3402b, 3402c, 3402d, a radio access network (RAN) 3404, a core network 3406, a public switched telephone network (PSTN) 3408, the Internet 3410, and other networks 3412, though it will be appreciated that the disclosed embodiments contemplate any number of WTRUs, base stations, networks, and/or network elements. Each of the WTRUs 3402a, 3402b, 3402c, 3402d may be any type of device configured to operate and/or communicate in a wireless environment. By way of example, the WTRUs 3402a, 3402b, 3402c, 3402d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 3400 may also include a base station 3414a and a base station 3414b. Each of the base stations 3414a, 3414b may be any type of device configured to wirelessly interface with at least one of the WTRUs 3402a, 3402b, 3402c, 3402d to facilitate access to one or more communication networks, such as the core network 3406, the Internet 3410, and/or the networks 3412. By way of example, the base stations 3414a, 3414b may be a base transceiver station (BTS), a Node-B, an eNode B, a Home Node B, a Home eNode B, a site controller, an access point (AP), a wireless router, and the like. While the base stations 3414a, 3414b are each depicted as a single element, it will be appreciated that the base stations 3414a, 3414b may include any number of interconnected base stations and/or network elements.

The base station 3414a may be part of the RAN 3404, which may also include other base stations and/or network elements (not shown), such as a base station controller (BSC), a radio network controller (RNC), relay nodes, etc. The base station 3414a and/or the base station 3414b may be configured to transmit and/or receive wireless signals within a particular geographic region, which may be referred to as a cell (not shown). The cell may further be divided into cell sectors. For example, the cell associated with the base station 3414a may be divided into three sectors. Thus, in one embodiment, the base station 3414a may include three transceivers, i.e., one for each sector of the cell. In another embodiment, the base station 3414a may employ multiple-input multiple output (MIMO) technology and, therefore, may utilize multiple transceivers for each sector of the cell.

The base stations 3414a, 3414b may communicate with one or more of the WTRUs 3402a, 3402b, 3402c, 3402d over an air interface 3416, which may be any suitable wireless communication link (e.g., radio frequency (RF), microwave, infrared (IR), ultraviolet (UV), visible light, etc.). The air interface 3416 may be established using any suitable radio access technology (RAT).

More specifically, as noted above, the communications system 3400 may be a multiple access system and may employ one or more channel access schemes, such as CDMA, TDMA, FDMA, OFDMA, SC-FDMA, and the like. For example, the base station 3414a in the RAN 3404 and the WTRUs 3402a, 3402b, 3402c may implement a radio technology such as Universal Mobile Telecommunications System (UMTS) Terrestrial Radio Access (UTRA), which may establish the air interface 3416 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 3414a and the WTRUs 3402a, 3402b, 3402c may implement a radio technology such as Evolved UMTS Terrestrial Radio Access (E-UTRA), which may establish the air interface 3416 using Long Term Evolution (LTE) and/or LTE-Advanced (LTE-A).

In other embodiments, the base station 3414a and the WTRUs 3402a, 3402b, 3402c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 3414b in FIG. 34A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 3414b and the WTRUs 3402c, 3402d may implement a radio technology such as IEEE 802.11 to establish a wireless local area network (WLAN). In another embodiment, the base station 3414b and the WTRUs 3402c, 3402d may implement a radio technology such as IEEE 802.15 to establish a wireless personal area network (WPAN). In yet another embodiment, the base station 3414b and the WTRUs 3402c, 3402d may utilize a cellular-based RAT (e.g., WCDMA, CDMA2000, GSM, LTE, LTE-A, etc.) to establish a picocell or femtocell. As shown in FIG. 34A, the base station 3414b may have a direct connection to the Internet 3410. Thus, the base station 3414b may not be required to access the Internet 3410 via the core network 3406.

The RAN 3404 may be in communication with the core network 3406, which may be any type of network configured to provide voice, data, applications, and/or voice over internet protocol (VoIP) services to one or more of the WTRUs 3402a, 3402b, 3402c, 3402d. For example, the core network 3406 may provide call control, billing services, mobile location-based services, pre-paid calling, Internet connectivity, video distribution, etc., and/or perform high-level security functions, such as user authentication. Although not shown in FIG. 34A, it will be appreciated that the RAN 3404 and/or the core network 3406 may be in direct or indirect communication with other RANs that employ the same RAT as the RAN 3404 or a different RAT. For example, in addition to being connected to the RAN 3404, which may be utilizing an E-UTRA radio technology, the core network 3406 may also be in communication with another RAN (not shown) employing a GSM radio technology.

The core network 3406 may also serve as a gateway for the WTRUs 3402a, 3402b, 3402c, 3402d to access the PSTN 3408, the Internet 3410, and/or other networks 3412. The PSTN 3408 may include circuit-switched telephone networks that provide plain old telephone service (POTS). The Internet 3410 may include a global system of interconnected computer networks and devices that use common communication protocols, such as the transmission control protocol (TCP), user datagram protocol (UDP) and the internet protocol (IP) in the TCP/IP internet protocol suite. The networks 3412 may include wired or wireless communications networks owned and/or operated by other service providers. For example, the networks 3412 may include another core network connected to one or more RANs, which may employ the same RAT as the RAN 3404 or a different RAT.

Some or all of the WTRUs 3402a, 3402b, 3402c, 3402d in the communications system 3400 may include multi-mode capabilities, i.e., the WTRUs 3402a, 3402b, 3402c, 3402d may include multiple transceivers for communicating with different wireless networks over different wireless links. For example, the WTRU 3402c shown in FIG. 34A may be configured to communicate with the base station 3414a, which may employ a cellular-based radio technology, and with the base station 3414b, which may employ an IEEE 802 radio technology.

FIG. 34B is a system diagram of an example WTRU 3402. As shown in FIG. 34B, the WTRU 3402 may include a processor 3418, a transceiver 3420, a transmit/receive element 3422, a speaker/microphone 3424, a keypad 3426, a display/touchpad 3428, non-removable memory 3430, removable memory 3432, a power source 3434, a global positioning system (GPS) chipset 3436, and other peripherals 3438. It will be appreciated that the WTRU 3402 may include any sub-combination of the foregoing elements while remaining consistent with an embodiment.

The processor 3418 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 3418 may perform signal coding, data processing, power control, input/output processing, and/or any other functionality that enables the WTRU 3402 to operate in a wireless environment. The processor 3418 may be coupled to the transceiver 3420, which may be coupled to the transmit/receive element 3422. While FIG. 34B depicts the processor 3418 and the transceiver 3420 as separate components, it will be appreciated that the processor 3418 and the transceiver 3420 may be integrated together in an electronic package or chip.

The transmit/receive element 3422 may be configured to transmit signals to, or receive signals from, a base station (e.g., the base station 3414a) over the air interface 3416. For example, in one embodiment, the transmit/receive element 3422 may be an antenna configured to transmit and/or receive RF signals. In another embodiment, the transmit/receive element 3422 may be an emitter/detector configured to transmit and/or receive IR, UV, or visible light signals, for example. In yet another embodiment, the transmit/receive element 3422 may be configured to transmit and receive both RF and light signals. It will be appreciated that the transmit/receive element 3422 may be configured to transmit and/or receive any combination of wireless signals.

In addition, although the transmit/receive element 3422 is depicted in FIG. 34B as a single element, the WTRU 3402 may include any number of transmit/receive elements 3422. More specifically, the WTRU 3402 may employ MIMO technology. Thus, in one embodiment, the WTRU 3402 may include two or more transmit/receive elements 3422 (e.g., multiple antennas) for transmitting and receiving wireless signals over the air interface 3416.

The transceiver 3420 may be configured to modulate the signals that are to be transmitted by the transmit/receive element 3422 and to demodulate the signals that are received by the transmit/receive element 3422. As noted above, the WTRU 3402 may have multi-mode capabilities. Thus, the transceiver 3420 may include multiple transceivers for enabling the WTRU 3402 to communicate via multiple RATs, such as UTRA and IEEE 802.11, for example.

The processor 3418 of the WTRU 3402 may be coupled to, and may receive user input data from, the speaker/microphone 3424, the keypad 3426, and/or the display/touchpad 3428 (e.g., a liquid crystal display (LCD) display unit or organic light-emitting diode (OLED) display unit). The processor 3418 may also output user data to the speaker/microphone 3424, the keypad 3426, and/or the display/touchpad 3428. In addition, the processor 3418 may access information from, and store data in, any type of suitable memory, such as the non-removable memory 3430 and/or the removable memory 3432. The non-removable memory 3430 may include random-access memory (RAM), read-only memory (ROM), a hard disk, or any other type of memory storage device. The removable memory 3432 may include a subscriber identity module (SIM) card, a memory stick, a secure digital (SD) memory card, and the like. In other embodiments, the processor 3418 may access information from, and store data in, memory that is not physically located on the WTRU 3402, such as on a server or a home computer (not shown).

The processor 3418 may receive power from the power source 3434, and may be configured to distribute and/or control the power to the other components in the WTRU 3402. The power source 3434 may be any suitable device for powering the WTRU 3402. For example, the power source 3434 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 3418 may also be coupled to the GPS chipset 3436, which may be configured to provide location information (e.g., longitude and latitude) regarding the current location of the WTRU 3402. In addition to, or in lieu of, the information from the GPS chipset 3436, the WTRU 3402 may receive location information over the air interface 3416 from a base station (e.g., base stations 3414a, 3414b) and/or determine its location based on the timing of the signals being received from two or more nearby base stations. It will be appreciated that the WTRU 3402 may acquire location information by way of any suitable location-determination method while remaining consistent with an embodiment.

The processor 3418 may further be coupled to other peripherals 3438, which may include one or more software and/or hardware modules that provide additional features, functionality and/or wired or wireless connectivity. For example, the peripherals 3438 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 34C is a system diagram of the RAN 3404 and the core network 3406 according to an embodiment. As noted above, the RAN 3404 may employ a UTRA radio technology to communicate with the WTRUs 3402a, 3402b, 3402c over the air interface 3416. The RAN 3404 may also be in communication with the core network 3406. As shown in FIG. 34C, the RAN 3404 may include Node-Bs 3440a, 3440b, 3440c, which may each include one or more transceivers for communicating with the WTRUs 3402a, 3402b, 3402c over the air interface 3416. The Node-Bs 3440a, 3440b, and 3440c may each be associated with a particular cell (not shown) within the RAN 3404. The RAN 3404 may also include RNCs 3442a and 3442b. It will be appreciated that the RAN 3404 may include any number of Node-Bs and RNCs while remaining consistent with an embodiment.

As shown in FIG. 34C, the Node-Bs 3440a and 3440b may be in communication with the RNC 3442a. Additionally, the Node-B 3440c may be in communication with the RNC 3442b. The Node-Bs 3440a, 3440b, 3440c may communicate with the respective RNCs 3442a and 3442b via an Iub interface. The RNCs 3442a and 3442b may be in communication with one another via an Iur interface. Each of the RNCs 3442a and 3442b may be configured to control the respective Node-Bs 3440a, 3440b, and 3440c to which it is connected. In addition, each of the RNCs 3442a and 3442b may be configured to carry out or support other functionality, such as outer loop power control, load control, admission control, packet scheduling, handover control, macrodiversity, security functions, data encryption, and the like.

The core network 3406 shown in FIG. 34C may include a media gateway (MGW) 3444, a mobile switching center (MSC) 3446, a serving GPRS support node (SGSN) 3448, and/or a gateway GPRS support node (GGSN) 3450. While each of the foregoing elements are depicted as part of the core network 3406, it will be appreciated that any one of these elements may be owned and/or operated by an entity other than the core network operator.

The RNC 3442a in the RAN 3404 may be connected to the MSC 3446 in the core network 3406 via an IuCS interface. The MSC 3446 may be connected to the MGW 3444. The MSC 3446 and the MGW 3444 may provide the WTRUs 3402a, 3402b, 3402c with access to circuit-switched networks, such as the PSTN 3408, to facilitate communications between the WTRUs 3402a, 3402b, 3402c and traditional land-line communications devices.

The RNC 3442a in the RAN 3404 may also be connected to the SGSN 3448 in the core network 3406 via an IuPS interface. The SGSN 3448 may be connected to the GGSN 3450. The SGSN 3448 and the GGSN 3450 may provide the WTRUs 3402a, 3402b, and 3402c with access to packet-switched networks, such as the Internet 3410, to facilitate communications between and the WTRUs 3402a, 3402b, 3402c and IP-enabled devices.

As noted above, the core network 3406 may also be connected to the networks 3412, which may include other wired or wireless networks that are owned and/or operated by other service providers.

FIG. 34D is a system diagram of the RAN 3404 and the core network 3406 according to an embodiment. As noted above, the RAN 3404 may employ an E-UTRA radio technology to communicate with the WTRUs 3402a, 3402b, and 3402c over the air interface 3416. The RAN 3404 may also be in communication with the core network 3406.

The RAN 3404 may include eNode-Bs 3460a, 3460b, and 3460c, though it will be appreciated that the RAN 3404 may include any number of eNode-Bs while remaining consistent with an embodiment. The eNode-Bs 3460a, 3460b, and 3460c may each include one or more transceivers for communicating with the WTRUs 3402a, 3402b, 3402c over the air interface 3416. In one embodiment, the eNode-Bs 3460a, 3460b, and 3460c may implement MIMO technology. Thus, the eNode-B 3460a, for example, may use multiple antennas to transmit wireless signals to, and receive wireless signals from, the WTRU 3402a.

Each of the eNode-Bs 3460a, 3460b, and 3460c may be associated with a particular cell (not shown) and may be configured to handle radio resource management decisions, handover decisions, scheduling of users in the uplink and/or downlink, and the like. As shown in FIG. 34D, the eNode-Bs 3460a, 3460b, and 3460c may communicate with one another over an X2 interface.

The core network 3406 shown in FIG. 34D may include a mobility management gateway (MME) 3462, a serving gateway 3464, and a packet data network (PDN) gateway 3466. While each of the foregoing elements are depicted as part of the core network 3406, it will be appreciated that any one of these elements may be owned and/or operated by an entity other than the core network operator.

The MME 3462 may be connected to each of the eNode-Bs 3462a, 3462b, and 3462c in the RAN 3404 via an Si interface and may serve as a control node. For example, the MME 3462 may be responsible for authenticating users of the WTRUs 3402a, 3402b, and 3402c, bearer activation/deactivation, selecting a particular serving gateway during an initial attach of the WTRUs 3402a, 3402b, 3402c, and the like. The MME 3462 may also provide a control plane function for switching between the RAN 3404 and other RANs (not shown) that employ other radio technologies, such as GSM or WCDMA.

The serving gateway 3464 may be connected to each of the eNode Bs 3460a, 3460b, and 3460c in the RAN 3404 via the Si interface. The serving gateway 3464 may generally route and forward user data packets to/from the WTRUs 3402a, 3402b, and 3402c. The serving gateway 3464 may also perform other functions, such as anchoring user planes during inter-eNode B handovers, triggering paging when downlink data is available for the WTRUs 3402a, 3402b, and 3402c, managing and storing contexts of the WTRUs 3402a, 3402b, 3402c, and the like.

The serving gateway 3464 may also be connected to the PDN gateway 3466, which may provide the WTRUs 3402a, 3402b, and 3402c with access to packet-switched networks, such as the Internet 3410, to facilitate communications between the WTRUs 3402a, 3402b, 3402c and IP-enabled devices.

The core network 3406 may facilitate communications with other networks. For example, the core network 3406 may provide the WTRUs 3402a, 3402b, 3402c with access to circuit-switched networks, such as the PSTN 3408, to facilitate communications between the WTRUs 3402a, 3402b, and 3402c and traditional land-line communications devices. For example, the core network 3406 may include, or may communicate with, an IP gateway (e.g., an IP multimedia subsystem (IMS) server) that serves as an interface between the core network 3406 and the PSTN 3408. In addition, the core network 3406 may provide the WTRUs 3402a, 3402b, and 3402c with access to the networks 3412, which may include other wired or wireless networks that are owned and/or operated by other service providers.

FIG. 34E is a system diagram of the RAN 3404 and the core network 3406 according to an embodiment. The RAN 3404 may be an access service network (ASN) that employs IEEE 802.16 radio technology to communicate with the WTRUs 3402a, 3402b, and 3402c over the air interface 3416. As will be further discussed below, the communication links between the different functional entities of the WTRUs 3402a, 3402b, and 3402c, the RAN 3404, and the core network 3406 may be defined as reference points.

As shown in FIG. 34E, the RAN 3404 may include base stations 3480a, 3480b, 3480c, and an ASN gateway 3482, though it will be appreciated that the RAN 3404 may include any number of base stations and ASN gateways while remaining consistent with an embodiment. The base stations 3480a, 3480b, and 3480c may each be associated with a particular cell (not shown) in the RAN 3404 and may each include one or more transceivers for communicating with the WTRUs 3402a, 3402b, and 3402c over the air interface 3416. In one embodiment, the base stations 3480a, 3480b, and 3480c may implement MIMO technology. Thus, the base station 3480a, for example, may use multiple antennas to transmit wireless signals to, and receive wireless signals from, the WTRU 3402a. The base stations 3480a, 3480b, and 3480c may also provide mobility management functions, such as handoff triggering, tunnel establishment, radio resource management, traffic classification, quality of service (QoS) policy enforcement, and the like. The ASN gateway 3482 may serve as a traffic aggregation point and may be responsible for paging, caching of subscriber profiles, routing to the core network 3406, and the like.

The air interface 3416 between the WTRUs 3402a, 3402b, and 3402c and the RAN 3404 may be defined as an R1 reference point that implements the IEEE 802.16 specification. In addition, each of the WTRUs 3402a, 3402b, and 3402c may establish a logical interface (not shown) with the core network 3406. The logical interface between the WTRUs 3402a, 3402b, 3402c and the core network 3406 may be defined as an R2 reference point, which may be used for authentication, authorization, IP host configuration management, and/or mobility management.

The communication link between each of the base stations 3480a, 3480b, and 3480c may be defined as an R8 reference point that includes protocols for facilitating WTRU handovers and the transfer of data between base stations. The communication link between the base stations 3480a, 3480b, and 3480c and the ASN gateway 3482 may be defined as an R6 reference point. The R6 reference point may include protocols for facilitating mobility management based on mobility events associated with each of the WTRUs 3402a, 3402b, 3402c.

As shown in FIG. 34E, the RAN 3404 may be connected to the core network 3406. The communication link between the RAN 3404 and the core network 3406 may be defined as an R3 reference point that includes protocols for facilitating data transfer and mobility management capabilities, for example. The core network 3406 may include a mobile IP home agent (MIP-HA) 3484, an authentication, authorization, accounting (AAA) server 3486, and a gateway 3488. While each of the foregoing elements are depicted as part of the core network 3406, it will be appreciated that any one of these elements may be owned and/or operated by an entity other than the core network operator.

The MIP-HA may be responsible for IP address management, and may enable the WTRUs 3402a, 3402b, and 3402c to roam between different ASNs and/or different core networks. The MIP-HA 3484 may provide the WTRUs 3402a, 3402b, and 3402c with access to packet-switched networks, such as the Internet 3410, to facilitate communications between the WTRUs 3402a, 3402b, and 3402c and IP-enabled devices. The AAA server 3486 may be responsible for user authentication and for supporting user services. The gateway 3488 may facilitate interworking with other networks. For example, the gateway 3488 may provide the WTRUs 3402a, 3402b, and 3402c with access to circuit-switched networks, such as the PSTN 3408, to facilitate communications between the WTRUs 3402a, 3402b, and 3402c and traditional land-line communications devices. In addition, the gateway 3488 may provide the WTRUs 3402a, 3402b, and 3402c with access to the networks 3412, which may include other wired or wireless networks that are owned and/or operated by other service providers.

Although not shown in FIG. 34E, it will be appreciated that the RAN 3404 may be connected to other ASNs and the core network 3406 may be connected to other core networks. The communication link between the RAN 3404 the other ASNs may be defined as an R4 reference point, which may include protocols for coordinating the mobility of the WTRUs 3402a, 3402b, and 3402c between the RAN 3404 and the other ASNs. The communication link between the core network 3406 and the other core networks may be defined as an R5 reference, which may include protocols for facilitating interworking between home core networks and visited core networks.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for configuring a group of user equipment to transfer a media flow between members of the group of user equipment, the method comprising:
receiving a group request message, wherein the group request message is associated with a first user equipment and the group of user equipment; and
configuring the group of user equipment based on the group request message, wherein the group of user equipment is configured to enable a transfer of the media flow from the first user equipment to a second user equipment when the first user equipment and the second user equipment are a member of the group of user equipment.

2. The method of claim 1, wherein the group request message is a join group request message, and wherein configuring the group of user equipment comprises adding the first user equipment to the group based on the join group request message.

3. The method of claim 2, further comprising sending an other group request message to notify a home agent that the first user equipment has been added to the group of user equipment.

4. The method of claim 1, wherein the group request message is a leave group request message, and wherein configuring the group of user equipment comprises removing the first user equipment from the group of user equipment based on the leave group request message.

5. The method of claim 1, wherein the group request message is an update group request message, and wherein configuring the group of user equipment comprises removing the first user equipment from the group if the periodic timer expires before receipt of the update group request message.

6. The method of claim 1, further comprising:
receiving a query group request message from the first user equipment; and
sending a query group response message to the first user equipment that includes the number of members that are included in the group of user equipment.

7. The method of claim 1, further comprising:
receiving a data group request message that includes data associated with the second user equipment; and
forwarding the data associated with the second user equipment to the first user equipment.

8. The method of claim 1, wherein the group request message is a mobile IP protocol message.

9. The method of claim 1, wherein the method is performed by a home agent.

10. The method of claim 1, wherein the method is performed by a session controller.

11. The method of claim 1, wherein the group of user equipment is included in a group table associated with each user equipment in the group of user equipment.

12. A method for enabling the transfer of a data flow between members of a group of user equipment, the method comprising:
receiving an indication to join a first user equipment to the group of user equipment;
sending a mobile IP group request message that is configured to join the first user equipment to the group of user equipment;
receiving data associated with a second user equipment that is a member of the group of user equipment; and
determining to transfer a data flow to the second user equipment based on the receive data.

13. The method of claim 12, further comprising:
receiving a mobile IP group request message that is configured to remove the first user equipment from the group of user equipment; and
clearing information associated with the group of user equipment from the first user equipment.

14. The method of claim 12, further comprising:
sending a query group request message to a home agent; and
receiving a query group response message comprising information that corresponds to each member of the group.

15. The method of claim 14, wherein the query group response message includes the number of members in the group.

16. The method of claim 12, further comprising sending a query group request message, wherein the query group request message includes an indication to turn off unrequested updates.

17. A method for replicating a media flow in a network for transmission to a user device, the method comprising:
receiving a request to replicate a media flow towards a plurality of user equipment;
sending a replication request message to the plurality of user equipment;
replicating the media flow; and
sending the replicated media flow to the plurality of user equipment.

18. The method of claim 17, wherein the replication request message is sent to the plurality of user equipment via each home agent corresponding to each user equipment of the plurality of user equipment.

19. The method of claim 17, wherein the replication request message is configured to prepare the plurality of user equipment for receiving the replicated media flow.

20. The method of claim 17, further comprising authorizing the replication of the media flow prior to performing the replicating step.
